(19) United States
(12) Patent Application Publication
(10) Pub. No.: US 2025/0357864 A1
(43) Pub. Date: Nov. 20, 2025

(54) VOLTAGE REGULATOR

(71) Applicant: The Penn State Research Foundation, University Park, PA (US)

(72) Inventors: Ramin Rahimzadeh Khorasani, University Park, PA (US); Rohit Sharma, University Park, PA (US); Madhavan Swaminathan, University Park, PA (US)

(21) Appl. No.: 19/071,014

(22) Filed: Mar. 5, 2025

Related U.S. Application Data
(60) Provisional application No. 63/648,449, filed on May 16, 2024.

(51) Int. Cl. H02M 3/158; H02M 1/00; H02M 3/07

(52) U.S. Cl. CPC H02M 3/1586; H02M 1/0058; H02M 1/0095; H02M 3/07

(57) ABSTRACT

Embodiments relate to a voltage regulator. The voltage regulator can include plural phase blocks. The plural phase blocks can include a single-stage multi-phase series capacitor buck converter configured to operate at a boundary between continuous conduction mode and discontinuous conduction mode.

### CROSS-REFERENCE TO RELATED APPLICATIONS

This patent application is related to and claims the benefit of priority of U.S. provisional application No. 63/648,449, filed on, May 16, 2024, the entire contents of which is incorporated herein by reference.

### FIELD OF THE INVENTION

Embodiments can relate to a voltage regulator with plural phase blocks that include a single-stage multi-phase series capacitor buck converter configured to operate at a boundary between continuous conduction mode and discontinuous conduction mode.

### BACKGROUND OF THE INVENTION

The Voltage Regulator Module (VRM), also known as a Processor Power Module (PPM), is a vital component in high-performance computing systems (HPC). On of its functions can be to provide microprocessors and chipsets with the precise supply voltage required for their operation. In conventional power delivery setups within servers and data centers, multiple down-conversion stages are typically required to achieve the necessary 1-V DC for processors (CPU).

### SUMMARY OF THE INVENTION

Exemplary embodiments can relate to a voltage regulator. The voltage regulator can include plural phase blocks. The plural phase blocks can include a single-stage multi-phase series capacitor buck converter configured to operate at a boundary between continuous conduction mode and discontinuous conduction mode.

In some embodiments, the voltage regulator can include plural processing modules. Each processing module can include one or more phase blocks.

In some embodiments, at least two phase blocks can be connected in parallel.

In some embodiments, each phase block can be connected in parallel with each other phase block.

In some embodiments, the plural phase blocks can include an input phase block. The input phase block can include a first diode switch, a second diode switch, a capacitor, and an inductor. The plural phase blocks can include an output phase block. The output phase block can include a first diode switch, a second diode switch, and an inductor.

In some embodiments, the voltage regulator can include an output capacitor.

In some embodiments, the input phase block can include plural phase blocks.

In some embodiments, the plural phase blocks can include an input phase block. The input phase block can include: a first diode switch connected to node 1 and connected to node 2; a capacitor connected to node 2 and connected to node 3; a second diode switch connected to node 3; and an inductor connected to node 3 and node 4. The plural phase blocks can include an output phase block. The output phase block can include: a first diode switch connected to node 2 and node 5; a capacitor connected to node 5 and node 6; a second diode switch connected to node 6; and an inductor connected to node 6 and node 7. The plural phase blocks can include an output capacitor connected to node 4, node 7, and node 8.

In some embodiments, the second diode switch connected to node 3 can include an amplifier, the second diode switch connected to node 6 can include an amplifier, and/or the output capacitor can include an amplifier.

In some embodiments, the voltage regulator can include a voltage source configured to generate a Vin at node 1. The voltage regulator can be configured to generate a Vout at node 8.

In some embodiments, the plural phase blocks can include a first processing module. The first processing module can include an input phase block, comprising: a first diode switch connected to node 1 and connected to node 2; a capacitor connected to node 2 and connected to node 3; a second diode switch connected to node 3; and an inductor connected to node 3 and node 4. The first processing module can include an output phase block, comprising: a first diode switch connected to node 2 and node 5; a capacitor connected to node 5 and node 6; a second diode switch connected to node 6; and an inductor connected to node 6 and node 7. The plural phase blocks can include a second processing module. The second processing module can include an input phase block, comprising: a first diode switch connected to node 1 and connected to node 2; a capacitor connected to node 2 and connected to node 3; a second diode switch connected to node 3; and an inductor connected to node 3 and node 4. The second processing module can include an output phase block, comprising: a first diode switch connected to node 2 and node 5; a capacitor connected to node 5 and node 6; a second diode switch connected to node 6; and an inductor connected to node 6 and node 7. The plural phase blocks can include an output capacitor connected to node 4, node 7, and node 8 of the first processing module and connected to node 4, node 7, and node 8 of the second processing module.

In some embodiments, the voltage regulator can include a voltage source configured to generate a Vin at node 1 of the first processing module and node 1 of the second processing module. The voltage regulator can be configured to generate a Vout at node 8 of the first processing module and node 8 of the second processing module.

In some embodiments, the voltage regulator can include a load connected to node 8 of the first processing module and connected to node 8 of the second processing module.

Exemplary embodiments can relate to a method for regulating voltage. The method can involve applying a voltage to a voltage regulator, the voltage regulator comprising plural phase blocks including a single-stage multi-phase series capacitor buck converter. The method can involve causing or allowing the single-stage multi-phase series capacitor buck converter to operate at a boundary between continuous conduction mode and discontinuous conduction mode.

Further features, aspects, objects, advantages, and possible applications of the present invention will become apparent from a study of the exemplary embodiments and examples described below, in combination with the Figures, and the appended claims.

### BRIEF DESCRIPTION OF THE DRAWINGS

The above and other objects, aspects, features, advantages and possible applications of the present innovation will be more apparent from the following more particular description thereof, presented in conjunction with the following drawings. Like reference numbers used in the drawings may identify like components.

FIGS. 1A, 1B, 1C, and 1D show a filter inductor output current of buck converter at 3 different operating modes: FIG. 1A shows a conventional buck converter, FIG. 1B shows an inductor current at Continuous Conduction Mode (CCM), FIG. 1C shows a Discontinuous Conduction Mode (DCM), and FIG. 1D shows a boundary of CCM/DCM.

FIGS. 2A, 2B, and 2C show a multi-phase block diagram for the an exemplary architecture: FIG. 2A shows a converter building block with two phases and series capacitors at the boundary of CCM/DCM with zero switching losses (=), FIG. 2B shows an exemplary Vin 2 three-phase block

$$\frac{{V}_{o}}{{V}_{i n}} = \frac{D}{3} ,$$

and FIG. 2C shows an exemplary interleaving technique with phase shift between FETs of each phase,

FIG. 3 shows inductor and output current waveforms in an exemplary two module, 4-phase architecture.

FIG. 4 shows theoretical key waveforms of an exemplary 3-phase, 2-module architecture showing a soft switching condition (Zero voltage turn-on and turn-off condition).

FIGS. 5A, 5B, and 5C show different multi-phase exemplary architectures made up of exemplary building blocks to reach high output currents up to 1000 A: FIG. 5A shows an exemplary 3-Phase: V₀/Vᵢₙ=D/3, FIG. 5B shows an exemplary 4-Phase: V₀/Vᵢₙ=D/4, and FIG. 5C shows an exemplary 6-Phase: V₀/Vᵢₙ=D/6.

FIG. 6 shows an exemplary package power delivery architecture using introduced IVR structure with embedded inductor networks at CCM/DCM boundary.

FIGS. 7A, 7B, and 7C illustrate various power delivery configurations for high-performance computing systems (HPCs).

FIGS. 8A, 8B, and 8C show a comparison of a synchronous buck converter at the boundary of CCM/DCM vs. CCM condition to demonstrate zero switching losses and smaller required inductance.

FIG. 9 shows an exemplary multi-phase high step-down series capacitor (SC) buck converter with zero turn-on switching losses at the CCM/DCM boundary condition.

FIG. 10 shows theoretical key waveforms of an exemplary multi-phase converter at CCM/DCM boundary condition.

FIGS. 11A, 11B, 11C, and 11D present a conceptual 3-D stack architecture for an exemplary 48/1 V, 1 kW, 4-phase, 8-module structure, employing two glass substrates and multiple ABF layers for interconnections.

FIG. 12 shows estimated dimension of an exemplary architecture using EPC GaN switches with 1 MHz switching frequency in comparison to the estimated package dimension of a 1 kW GPU.

FIGS. 13A and 13B show power delivery architectures for the next generation of HPCs to reduce routing losses. FIG. 13A shows INTEL Ponte Vecchio GPU (600 W), using multiple stages of converters where VRM is integrated in the GPU. FIG. 13B shows this work: Integrated 48-12/1 V IVR inside the processor's package with negligible routing losses.

FIGS. 14A and 14B shows exemplary fundamental blocks of multi-phase step-down converters operating in continuous conduction mode (CCM) with (FIG. 14A) series capacitors and (FIG. 14B) flying capacitors, wherein CCM operation necessitates a relatively large inductance, with top-side switches experiencing switching losses.

FIGS. 15A and 15B show an exemplary step-down series capacitor (SC) buck converter with zero turn-on switching losses at the CCM/DCM boundary condition utilizing relatively small inductances. FIG. 15A shows a converter with 4 interleaved phases and 2 interleaved modules to increase power and reduce inductor current ripple, and FIG. 15B shows theoretical key waveforms.

FIG. 16 shows an exemplary discrete version of the converter on printed circuit board (PCB) using EPC 2066 GaN Switches and Coilcraft air core inductors. (250 W, 48/1 V).

FIG. 17 (panels A, B, C, and D) show an exemplary 3-D stacked package power delivery architecture with the proposed 4-phase, 8-module IVR (1 kW, 48/1 V): (Panel A) 3-D view, (Panel B) top (Panel C) front side, and (Pane C) back side.

FIG. 18 shows estimated dimension of the proposed architecture using EPC GaN switches with 1 MHz switching frequency in comparison to the estimated package dimension of a 1 kW GPU. Increasing the switching frequency of the IVR to the range of 10-100 MHz holds substantial potential for significantly minimizing its overall dimension.

FIG. 19 (panels (a), (b), (c), (d), (e), (f), (g), (h), and (i)) show experimental waveforms.

FIG. 20 (panels (a) and (b)) show current waveforms.

### DETAILED DESCRIPTION OF THE INVENTION

The following description is of exemplary embodiments that are presently contemplated for carrying out the present invention. This description is not to be taken in a limiting sense, but is made merely for the purpose of describing the general principles and features of the present invention. The scope of the present invention is not limited by this description.

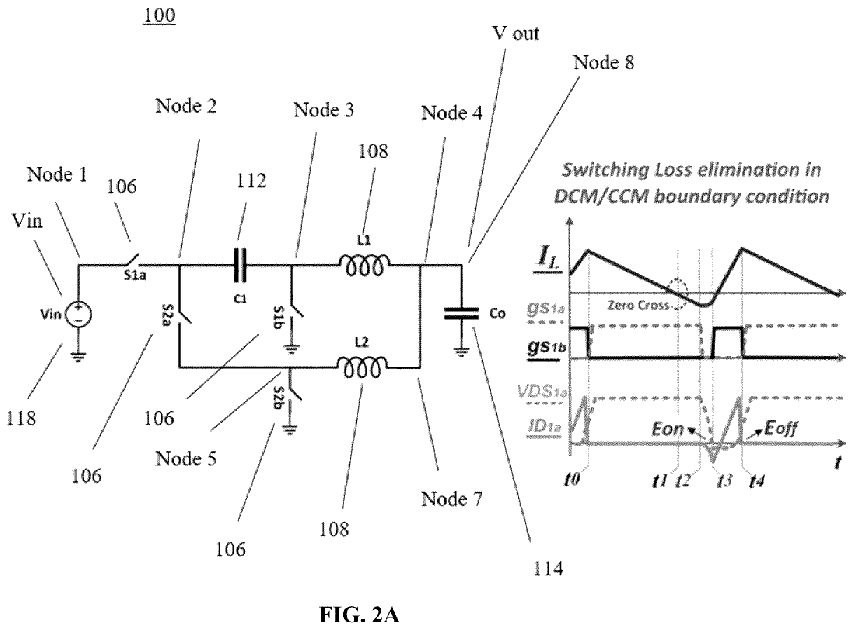

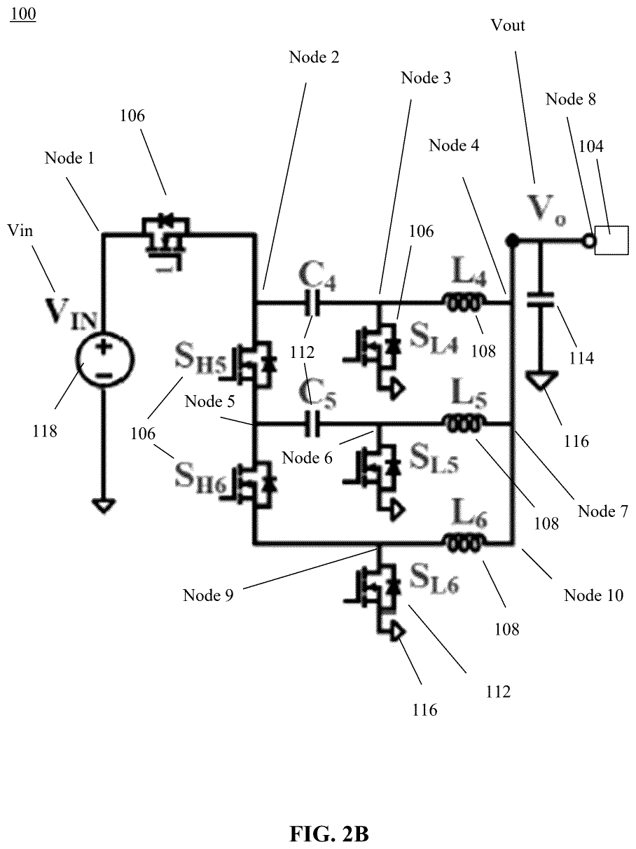

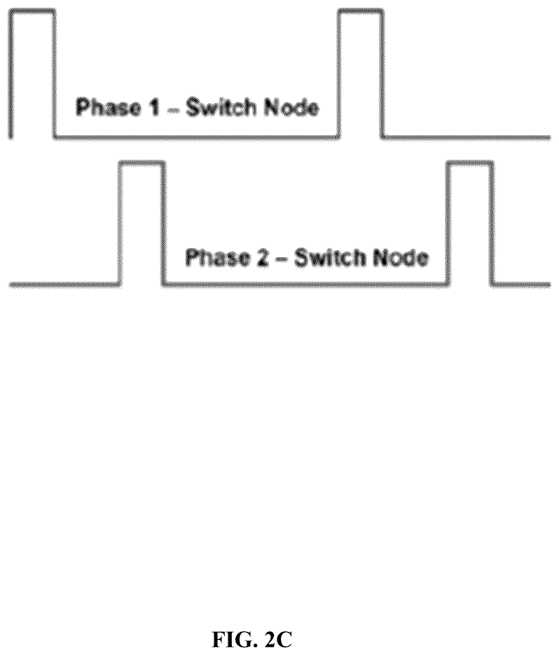

Referring to FIGS. 2-6 and 9, exemplary embodiments can relate to a voltage regulator 100. The voltage regulator 100 can include plural phase blocks 102. The plural phase blocks 102 can include a single-stage multi-phase series capacitor buck converter configured to operate at a boundary between continuous conduction mode and discontinuous conduction mode. With this set-up, the voltage regulator 100 can efficiently transfer high powers (e.g., up to 1 kW) from a 12 V or 48 V input source to one or more loads 102. In addition, the set-up provides for an absence of switching losses, which can facilitate soft switching and further enhance overall efficiency. For instance, the voltage regulator 100 can be configured to impose a boundary condition for the inductor current of the output filter of the regulator 100, which facilitates efficient discharge of the switch's/switches' 106 output capacitance during the off phase. Another advantage is the ability to use small indictors 108 in the voltage regulator 100. This not only leads to high power density, but also provides the ability to use embedded indictors 108. As will be demonstrated herein, the voltage regulator 100 can significantly reduce inductance for each phase (0.6 nH to 4.5 nH) at 1-5 MHz switching frequency, while accommodating currents exceeding 100 amperes per phase. High power density can provide the flexibility to adapt to various computing requirements, making the voltage regulator 100 suitable for a wide range of applications within high-performance computing systems. This allows for a seamless integration of embedded inductors and higher power density for integrated versions of the voltage regulator 100.

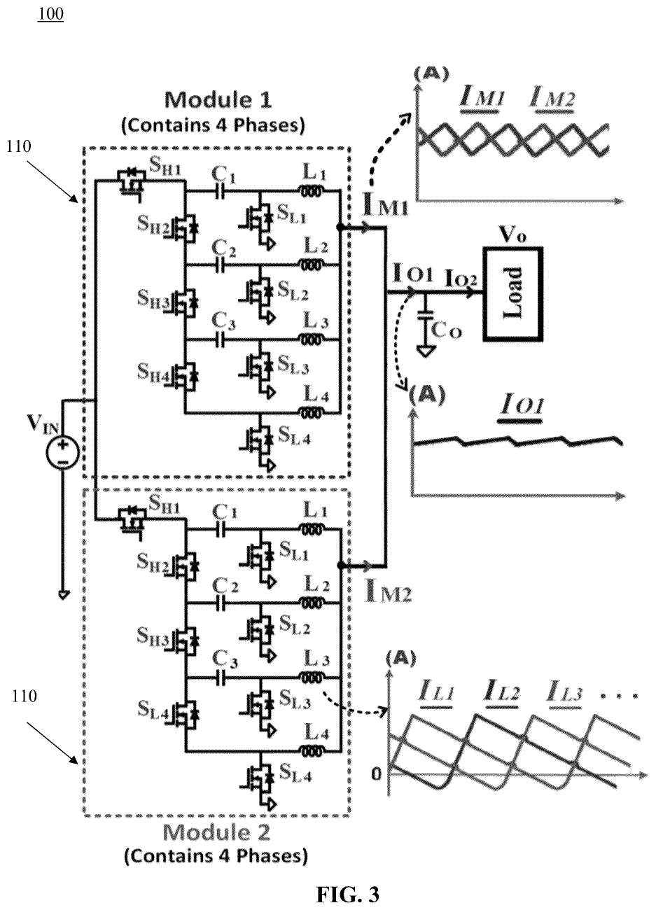

Embodiments of the voltage regulator 100 can be configured to include plural processing modules 110 (see FIG. 3). Each processing module 110 can include one or more phase blocks 102. For instance, the voltage regulator 100 can have a first processing module 110, a second processing module 110, a third processing module 110, etc. The first processing module 110 can have one phase block 102, for example. The second processing module 110 can have two phase blocks 102, for example. The third processing module 110 can have three phase blocks 102, for example. There can be any number, combination, permutations, etc. of processing modules 110, phase blocks 102, etc.

It is contemplated for each phase block 102 to be connected in parallel with each other phase block 102. For instance, sticking with the example above, each of the three phase blocks 102 of the third processing module 110 can be connected in parallel with each other, and each of the two phase blocks 102 of the second processing module 110 can be connected in parallel with each other. In addition, each phase block 102 of the third processing module 110 can be connected in parallel with each phase block 102 of the second processing module 110, and each phase block 102 of the third and second processing modules 110 can be connected in parallel with the phase block 102 of the first processing module 110. It is understood that there can be any number, combination, permutation, etc. of phase blocks 102 connected in parallel—e.g., there may be some phase blocks 102 that are not connected in parallel.

The volage regulator 100 can be configured to have an input phase block 102 and an output phase block 102. The input phase block 102 can be the component(s) of the voltage regulator 100 that receive an input voltage Vin or have an input voltage Vin applied to it. The output phase block 102 can be the component(s) that are connected to an output node for generating a voltage output Vout. There can be one or more input phase blocks 102. While it is contemplated for there to be only one output phase block 102, there can be more than one. Each input phase block 102 can include a first diode switch 106, a second diode switch 106, a capacitor 112, and an inductor 108. The output phase block 102 can include a first diode switch 106, a second diode switch 106, and an inductor 108.

The voltage regulator 100 can include one or more output capacitors 114. For example, the voltage regulator 100 can include an output capacitor 114 in connection with the output node. It is contemplated for the output capacitor 114 to be in connection with the output phase block 102 and the output node.

Referring to FIG. 2A, as a non-limiting example, the plural phase blocks 102 can include an input phase block 102. The input phase block 102 can include a first diode switch 106 connected to node 1 and connected to node 2. The input phase block 102 can include a capacitor 112 connected to node 2 and connected to node 3. The input phase block 102 can include a second diode switch 106 connected to node 3. The input phase block 102 can include an inductor 108 connected to node 3 and node 4. The plural phase blocks 102 can include an output phase block 102. The output phase block 102 can include a first diode switch 106 connected to node 2 and node 5. The output phase block 102 can include a capacitor 112 connected to node 5 and node 6. The output phase block 102 can include a second diode switch 106 connected to node 6. The output phase block 102 can include an inductor 108 connected to node 6 and node 7. The plural phase blocks 102 can include an output capacitor 114 connected to node 4, node 7, and node 8.

Referring to FIG. 2B, as another non-limiting example, the plural phase blocks 102 can include a first input phase block 102. The first input phase block 102 can include a first diode switch 106 connected to node 1 and connected to node 2. The first input phase block 102 can include a capacitor 112 connected to node 2 and connected to node 3. The first input phase block 102 can include a second diode switch 106 connected to node 3. The first input phase block 102 can include an inductor 108 connected to node 3 and node 4. The plural phase blocks 102 can include a second input phase block 102. The second input phase block 102 can include a first diode switch 106 connected to node 2 and node 5. The second input phase block 102 can include a capacitor 112 connected to node 5 and node 6. The second input phase block 102 can include a second diode switch 106 connected to node 6. The second input phase block 102 can include an inductor 108 connected to node 6 and node 7. The plural phase blocks 102 can include an output phase block 102. The output phase block 102 can include a first diode switch 106 connected to node 5 and node 9. The output phase block 102 can include a second diode switch 106 connected to node 9. The output phase block 102 can include an inductor 108 connected to node 9 and node 10. The plural phase blocks 102 can include an output capacitor 114 connected to node 4, node 7, node 10, and node 8.

In some embodiments, the second diode switch 106 connected to node 3 can include an amplifier 116, the second diode switch 106 connected to node 6 can include an amplifier 116, and/or the output capacitor 114 can include an amplifier 116.

The voltage regulator 100 can include a voltage source(s) 118, be in connection with a voltage source(s) 118, or be configured to be connected to a voltage source(s) 118. The voltage source(s) 118 can be configured to generate an input voltage Vin at node 1. The voltage regulator 100 can be configured to generate an output voltage Vout at node 8. The voltage regulator 100 can include a load(s) 102, be in connection with a load(s) 102, or be configured to be connected to a load(s) 102. The load(s) 102 can be connected to node 8.

Referring to FIG. 3, as another non-limiting example, the plural phase blocks 102 can include a first processing module 110. The first processing module 110 can include an input phase block 102. The input phase block 102 can include a first diode switch 106 connected to node 1 and connected to node 2. The input phase block 102 can include a capacitor 112 connected to node 2 and connected to node 3. The input phase block 102 can include a second diode switch connected to node 3. The input phase block 102 can include an inductor 108 connected to node 3 and node 4. The first processing module 110 can include an output phase block 102. The output phase block 102 can include a first diode switch 106 connected to node 2 and node 5. The output phase block 102 can include a capacitor 112 connected to node 5 and node 6. The output phase block 102 can include a second diode switch 106 connected to node 6. The output phase block 102 can include an inductor 108 connected to node 6 and node 7. The plural phase blocks 102 can include a second processing module 110. The second processing module 110 can include an input phase block 102. The input phase block 102 can include a first diode switch 106 connected to node 1 and connected to node 2. The input phase block 102 can include a capacitor 112 connected to node 2 and connected to node 3. The input phase block 102 can include a second diode switch 106 connected to node 3. The input phase block 102 can include an inductor 108 connected to node 3 and node 4. The second processing module 110 can include an output phase block 102. The output phase block 102 can include a first diode switch 106 connected to node 2 and node 5. The output phase block 102 can include a capacitor 112 connected to node 5 and node 6. The output phase block 102 can include a second diode switch 106 connected to node 6. The output phase block 102 can include an inductor 108 connected to node 6 and node 7. The plural phase blocks 102 can include an output capacitor 114 connected to node 4, node 7, and node 8 of the first processing module 110 and connected to node 4, node 7, and node 8 of the second processing module 110.

A voltage source(s) 118 can be configured to generate an input voltage Vin at node 1 of the first processing module 110 and node 1 of the second processing module 110. The voltage regulator 100 can be configured to generate an output voltage Vout at node 8 of the first processing module 110 and node 8 of the second processing module 110.

A load(s) 102 can be connected to node 8 of the first processing module 110 and connected to node 8 of the second processing module 110.

As can be appreciated from the present disclosure, an embodiment can relate to a method for regulating voltage. The method can involve applying a voltage Vin to a voltage regulator 100. The voltage regulator 100 can include plural phase blocks 102 with a single-stage multi-phase series capacitor buck converter. The method can involve causing or allowing the single-stage multi-phase series capacitor buck converter to operate at a boundary between continuous conduction mode and discontinuous conduction mode to generate a voltage output Vout. For instance, the plural phase blocks 102 can include an input phase block 102. The input phase block 102 can include a first diode switch 106 connected to node 1 and connected to node 2. The input phase block 102 can include a capacitor 112 connected to node 2 and connected to node 3. The input phase block 102 can include a second diode switch 106 connected to node 3. The input phase block 102 can include an inductor 108 connected to node 3 and node 4. The plural phase blocks 102 can include an output phase block 102. The output phase block 102 can include a first diode switch 106 connected to node 2 and node 5. The output phase block 102 can include a capacitor 112 connected to node 5 and node 6. The output phase block 102 can include a second diode switch 106 connected to node 6. The output phase block 102 can include an inductor 108 connected to node 6 and node 7. The plural phase blocks 102 can include an output capacitor 114 connected to node 4, node 7, and node 8. The method can involve applying an input voltage Vin at node 1 and allowing the voltage regulator 100 to generate an output voltage Vout at node 8.

### Examples

The following examples include exemplary implementations and test results of embodiments disclosed herein.

Embodiments of the disclosed VRM design features a single-stage multi-phase series capacitor buck converter. Embodiments of the V RM design can operate at the boundary of Continuous-Discontinuous Conduction Mode (CCM-DCM) and efficiently transfers high powers, up to 1 kW, from a 12 V or 48 V input source to the load. Moreover, the absence of switching losses can allow for soft switching, which can contribute to the system's overall efficiency.

The use of small inductors in embodiments of the design can facilitate integration of embedded inductors and achieving high-power density. This characteristic can make the disclosed VRM design an excellent choice for integrated voltage regulators (IVR). With some embodiments, the modular nature of the design can empower it to generate output currents up to 1 kA for individual chips and an impressive 20 kA for servers. This level of flexibility can ensure that the VRM can adapt to various computing requirements, making it suitable for a wide range of applications within high-performance computing systems. In summary, embodiments of the VRM technology can represent a significant advancement in power delivery for high-performance computing systems. By offering enhanced efficiency and performance without the complexities of traditional setups, embodiments of the disclosed design can provide for a more efficient solution for power delivery in IPC applications.

One approach to reducing the required inductance for HPC's power delivery and integrate embedded inductors for currents up to 1 kA, embodiments of the voltage regulator structure can be configured to operate at the boundary of continuous-discontinuous conduction mode (CCM-DCM). This approach can significantly reduce inductance for each phase (0.6 nH to 4.5 nH) at 1-5 MHz switching frequency while accommodating currents exceeding 100 amperes per phase, which can enable the seamless integration of embedded inductors and higher power density for integrated versions of VRMs. The existing CCM V RMs require larger inductance to regulate output current.

Additionally, the efficient discharge of the switches' output capacitance during the off phase of the disclosed approach can eliminate switching losses, which can allow for higher frequencies with wide-bandgap power transistors. Unlike traditional architectures, embodiments disclosed herein can eliminate switching losses without the need for additional components, which can result in a highly efficient system. Requiring FET's zero switching loss can be achieved at the cost of using higher components in the existing VRMs. Despite employing small inductance and accordingly having high inductor ripple current, the technique of interleaving phases and modules employed in the disclosed system can effectively reduce output current ripple, which can lessening the reliance on large capacitors. This approach can optimize the overall efficiency and performance of the power delivery system.

Another benefit can be the ability to develop a System on Package (SOP) vertical power delivery architecture capable of delivering high power of 1 kW from PCB to POL at high current density and PCB-to-POL efficiency\.

With the examples discussed herein, a voltage regulator module (VRM) with enhanced power density and high efficiency is introduced. Embodiments of the disclosed architecture include of a modular multi-phase step-down series capacitor buck converter operating at the boundary of Continuous-Discontinuous Conduction Mode (CCM-DCM). The design can include a boundary condition for the inductor current of the output filter, ensuring efficient discharge of the switches' output capacitance during the off phase. This can result in zero turn-on switching losses and zero capacitive turn-on losses. Consequently, higher frequencies can be achieved using wide-bandgap gallium nitride (GaN) power transistors, leading to smaller filter sizes and higher overall efficiency. Additionally, the use of interleaving phases and modules to reach 1 kA output current, along with inductors' boundary condition, can facilitate the use of smaller inductor values while maintaining a small output ripple current. This, in turn, can further improve the size of magnetic elements and enhances power density for integrated voltage regulator modules (IVRs), which can be highly appliable for package power delivery in next-generation data centers, specifically tailored for high performance computing systems (HPC). The multi-phase and modular design of the converter can allow for output currents of up to 1 kA or more, with voltage ratios of 48 V-to −1 V or 12V-to −1V @1 kW and switching frequencies up to 10 MHz.

### Example 1

As discussed herein, a Voltage Regulator Module (VRM), also known as a Processor Power Module (PPM), functions as a step-down DC-DC switching converter. It is comprised of high-frequency semiconductors and their control circuits, alongside passive filter components including capacitors and inductors. This module plays a crucial role in supplying the microprocessor and chipset with the necessary voltage, converting higher voltages like +3.3 V, +5 V, or +12 V to lower voltages, typically around 1 V or even lower, as per the specific requirements of devices. The majority of VRM implementations operate in Continuous Conduction Mode (CCM), where the inductor current in the output filter circuit never drops to zero. However, there exists another mode called Discontinuous Conduction Mode (DCM), where the inductor current falls to zero. DCM finds applications in specific scenarios, especially in low-current and loop-compensation applications.

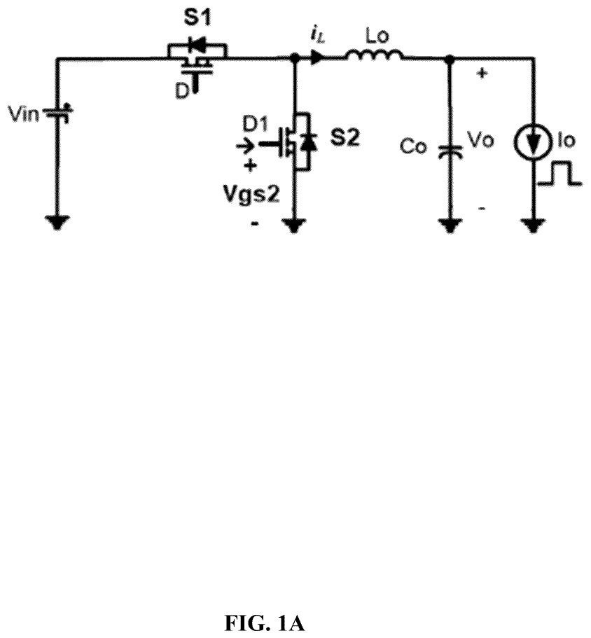

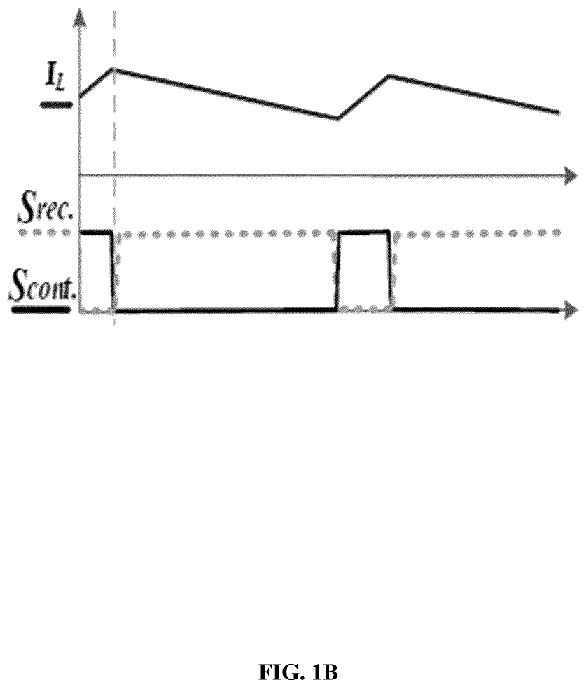

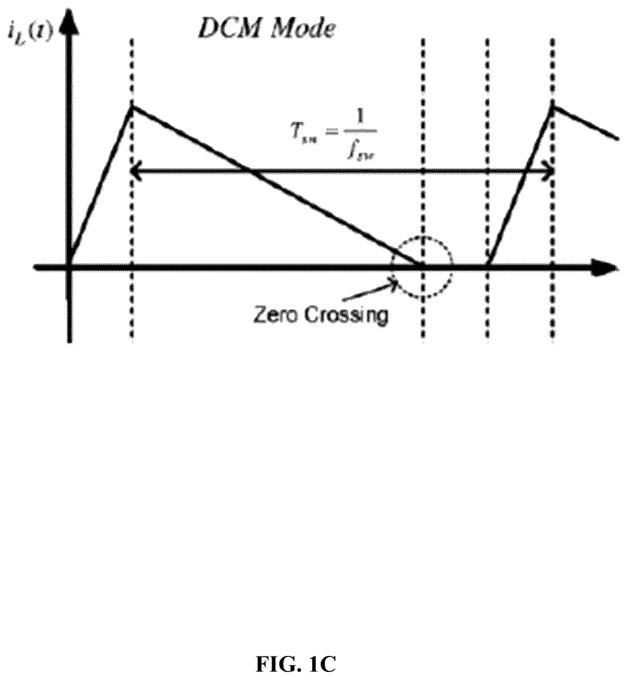

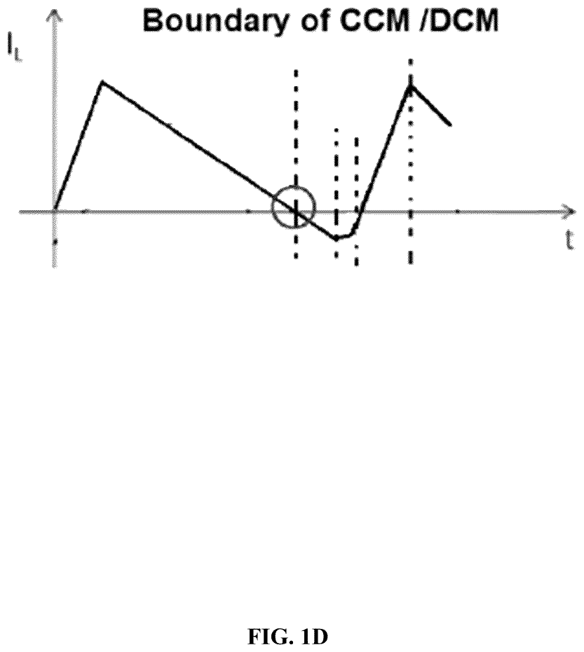

In a basic buck-type step-down converter, the behavior of the freewheeling diode (which can be replaced by a switch in low output voltage applications) is determined by the relationship between the peak inductor current ripples and the DC component of the inductor current. When the ripples are lower than the DC component (continuous conduction mode (CCM)), the freewheeling diode is forced to turn on, or the synchronous switch must conduct during the off state of the top switch Si. This occurs because the positive inductor current is channeled through the diode in the freewheeling mode, as illustrated in FIG. 1A and FIG. 1B. Conversely, if the peak of the inductor current ripples surpasses the DC component, the inductor current does not persist throughout the entire cycle and reaches zero earlier, even before the freewheeling period concludes. In this scenario, the diode ceases to conduct until switch Si is gated again, maintaining the inductor current at zero. This situation characterizes the discontinuous conduction mode (DCM) in the DC-to-DC converter, as depicted in FIG. 1C. The inductance for DCM condition is lower than the minimum value required for CCM condition, denoted as LDCM<LCCM. This condition typically arises in the light-load state of CCM operation. In the case of DCM operation, the peak inductor current requirement is higher compared to CCM, leading to increased losses in DCM-based converters.

In FIG. 1D, the DCM/CCM boundary operation is shown, adding an additional operating mode to the inductor current. This mode offers the advantage of discharging the top switch capacitor during the off time, called soft switching condition. This results in zero turn-on switching losses (Eon) and zero capacitive turn-on losses (Eoss) through zero voltage switching (ZVS) condition. In the boundary condition, once the inductor current reaches zero, the bottom switch will be turned off after a specific delay to provide a small negative inductor current. This is unlike the DCM condition, where the inductor current remains zero until the next period of the switch cycle. Once the inductor current becomes negative and the bottom switch turns off, the inductor current passes through the top switch's parasitic capacitance (C_{OSS}) and discharges it into the zero voltage in a very short period and recovers its Eoss energy into the input source. Then the top switch can be turned on while it has zero drain-source voltage. This results in no overlap between the voltage and current of the switch once it turns on.

FIGS. 1A-1D show a filter inductor output current of buck converter at three different operating modes: FIG. 1A shows a conventional buck converter, FIG. 1B shows an inductor current at Continuous Conduction Mode (CCM), FIG. 1C shows a Discontinuous Conduction Mode (DCM), and FIG. 1D shows a boundary of CCM/DCM.

Buck converters and four-switch buck-boost converters are candidates for step-down voltage ratios (12V-to −1V, 48V-to −1V). However, under high step-down ratio conditions, these basic converters face serious challenges in regulating their output voltage. The duration over which the top FET stays on during each switching period (T) in continuous conduction mode (CCM) is calculated using the equation:

$${t}_{on ( Top \_ switch )} = \frac{{V}_{out}}{{V}_{i n}} * \frac{1}{{f}_{sw}} \qquad ( 1 )$$

According to this equation, the switch on-time (tₒₙ) decreases when the input-to-output voltage ratio (VIN/VOUT) and/or switching frequency (f_{sw}) increase. This means that the buck converter must be able to operate with very low tₒₙ to regulate the output voltage in CCM under a high VIN/VOUT ratio, which becomes even more challenging with a high f_{sw}. In other words, as the difference between input and output voltage rises, the switching frequency must decrease due to the limitation of the minimum tₒₙ of semiconductor switches. Lower switching frequencies result in larger filters and lower power density of the converter.

FIG. 2 shows a fundamental multi-phase block for the introduced architecture: FIG. 2A shows a converter building block with two phases and series capacitors at the boundary of CCM/DCM with zero switching losses

$$( \frac{{V}_{o}}{{V}_{i n}} = \frac{D}{2} )$$

FIG. 2B shows a three-phase block

$$\frac{{V}_{o}}{{V}_{i n}} = \frac{D}{3} ,$$

and FIG. 2C shows an interleaving technique with phase shift between FETs of each in phase.

To tackle the challenge of lower tₒₙ associated with higher input voltages, such as 48V, researchers have explored hybrid series capacitor buck converters. A common strategy for enhancing converter power and current capabilities involves employing modular VRM architectures with parallel phases. Embodiments of the disclosed VRM architecture are capable of delivering a substantial power output of 1 kW, coupled with high current density and high efficiency

Embodiments of the disclosed architecture can incorporate multi-phase series-capacitor buck converters operating precisely at the boundary between Continuous Conduction Mode (CCM) and Discontinuous Conduction Mode (DCM). Despite the presence of considerable ripple current in the inductors, this structure can achieve a delicate balance through the charge distribution across capacitors and effective current sharing among parallel phases, all without the need for additional control circuits or components. FIGS. 2A-2C provide a visual representation of exemplary architectures. As can be appreciated, embodiments can provide for an interleaved multi-phase series-capacitor buck converter operating precisely at the CCM/DCM boundary. By increasing the number of phases, not only does the output current and power increase, but also the voltage gain ratio of the converter expands, enabling larger tₒₙ and duty cycles.

FIG. 3 shows inductor and output current waveforms in a two module, 4-phase architecture. As can be appreciated, embodiments can significantly reduce the inductance required for each phase. Despite the presence of high inductor ripple current, the interleaving of phases and modules effectively minimizes output current ripple, reducing the dependence on oversized capacitors. FIG. 3 displays a two-module, 4-phase architecture, presenting waveforms of inductor current, current for each module, and the resulting output current ripple. This exemplary architecture demonstrates the impact of interleaving between phases and parallel modules, showcasing its ability to deliver 1 kW power at 1 V.

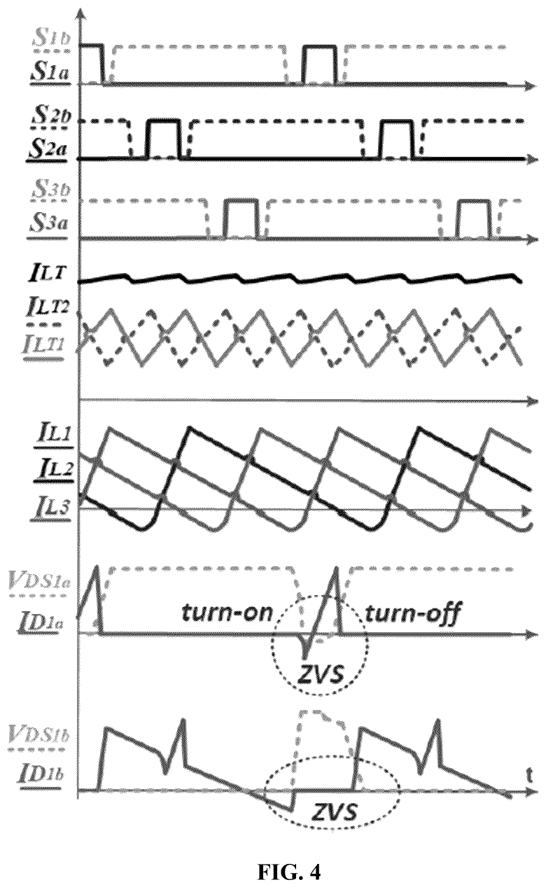

In FIG. 4, key waveforms of an exemplary architecture are illustrated. More specifically, FIG. 4 shows theoretical key waveforms of an exemplary 3-phase, 2-module architecture showing a soft switching condition (Zero voltage turn-on and turn-off condition). This diagram demonstrates the efficient discharge of the switches' output capacitance during the off phase, establishing a zero-voltage switching (ZVS) condition during turn-on instances. As can be appreciated, embodiments can eliminate Eon and Eoss switching losses, permitting the use of higher frequencies with wide-bandgap power transistors while maintaining lower switch temperatures. Furthermore, the inherent capacitor (C_{OSS}) of the top switch minimizes the overlap between voltage and current during turn-off instances, nearly achieving a ZVS condition during this phase. This ZVS soft switching condition also applies to the bottom switch, as depicted in the diagram. During a brief period when the inductor current becomes negative, the switch output capacitor (C_{OSS (bottom switch)}) discharges, allowing the switch to turn on and off under ZVS conditions.

Design considerations for 1 kW@1V load.

In this study, synchronous buck-derived Voltage Regulator Modules (VRMs) with varying phases (ranging from 3 to 12) and approximately 100 amperes per phase, operating at the boundary between Continuous Conduction Mode (CCM) and Discontinuous Conduction Mode (DCM), were simulated. To minimize conduction losses, low resistance EPC2066 GaN power transistors (R_{DS}=1−mΩ) were utilized. These transistors, featuring a single high-side switch and two low-side switches, occupied a compact area of 6.9 mm×6.03 mm per phase.

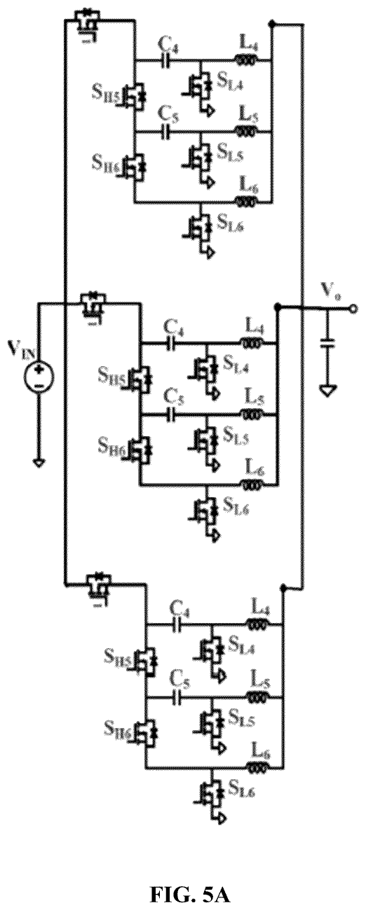

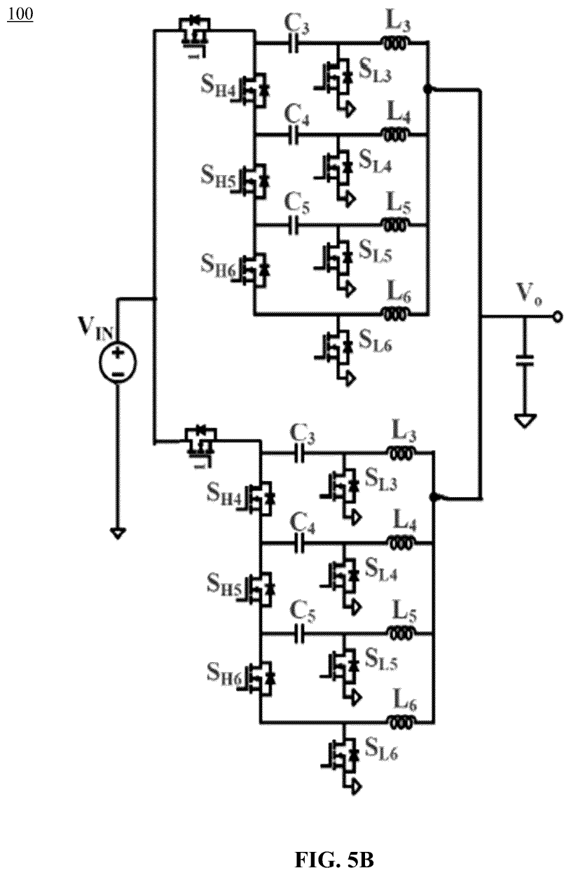

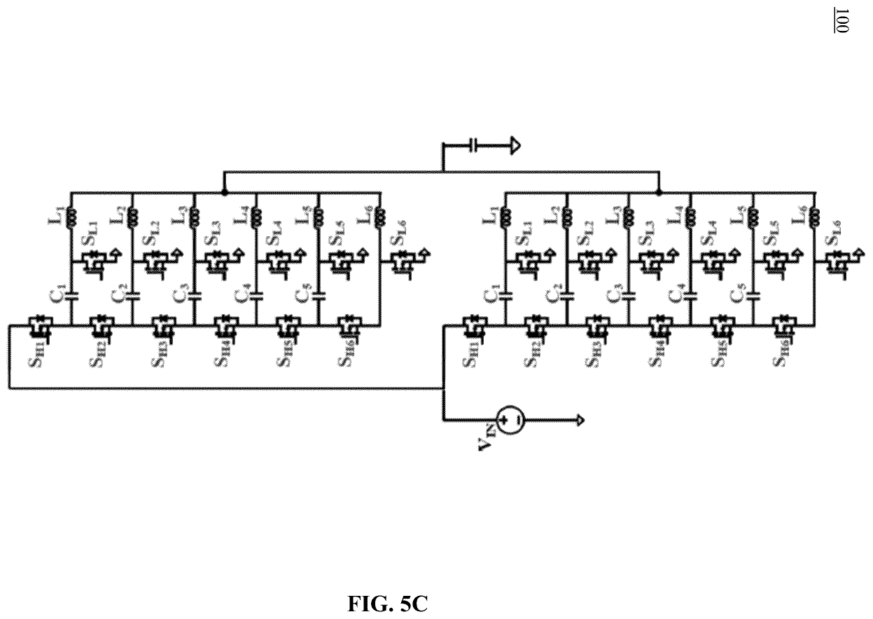

For a specific configuration involving a two-module and 4-phase architecture (totaling 8 phases), the total inductance per phase was measured at 2.5 nH for 1 MHz and 0.65 nH for 4 MHz switching frequencies. Various architectures of the proposed converter, ranging from 3 to 12 phases and 2 to 5 parallel modules utilizing a phase shift (interleaving technique), were systematically simulated, and analyzed. FIGS. 5A, 5B, and 5C visually depict these diverse approaches aimed at achieving 1 kA output current. More specifically, FIGS. 5A, 5B, and 5C show different multi-phase architectures made up of exemplary building blocks to reach high output currents up to 1000 A: FIG. 5A shows an exemplary 3-Phase: V₀/Vᵢₙ=D/3, FIG. 5B shows an exemplary 4-Phase: V₀/Vᵢₙ=D/4, and FIG. 5C shows an exemplary 6-Phase: V₀/Vᵢₙ=D/6.

Selecting the appropriate number of phases and modules necessitates a careful balance between multiple factors, including output current ripple, voltage gain ratio, switch duty cycle, gate drive loss, and conduction losses within the converter. This intricate trade-off process will be explored to optimize the system's performance. In the case of embedded inductors, composite magnetic sheets served as the core material. The innovative converter design showcased zero switching losses, eliminating the necessity for auxiliary active or passive components. This stands in a clear contrast to conventional CCM VRMs experiencing hard switching, which inevitably leads to reduced efficiency. Although increasing the frequency from 1 MHz to 4 MHz leads to a reduction in inductor values, it concurrently amplifies gate driver losses and reduces light load efficiency. Achieving the optimum frequency demands a precise balance between inductor losses and Field-Effect Transistor (FET) losses.

### Impact.

Embodiments of the VRM architecture using the exemplary circuitry disclosed herein at the CCM/DCM boundary, operating at MHz switching frequency and employing Zero Voltage Switching (ZVS), can significantly increase power density and efficiency. The approach disclosed herein not only advances VRMs in terms of power density and efficiency for High-Performance Computing (HPC) systems but also opens up new avenues, such as:
1) Utilizing a network of small, embedded inductors for System on Package (SOP) power delivery architectures employing Integrated Voltage Regulators (IVRs).
2) Addressing the challenge of lower switching frequencies linked to higher input voltages (48-V) system on package integrated VRs.
3) Achieving efficient power delivery in SOP configurations, especially in high-performance computing applications where individual chips draw 1-kA and servers demand 20-kA. This is crucial due to the increased need for higher inductance, space constraints, and the limitations of embedded inductors, which are restricted to peak currents of 5-A and a maximum inductance of 600-900-nH.

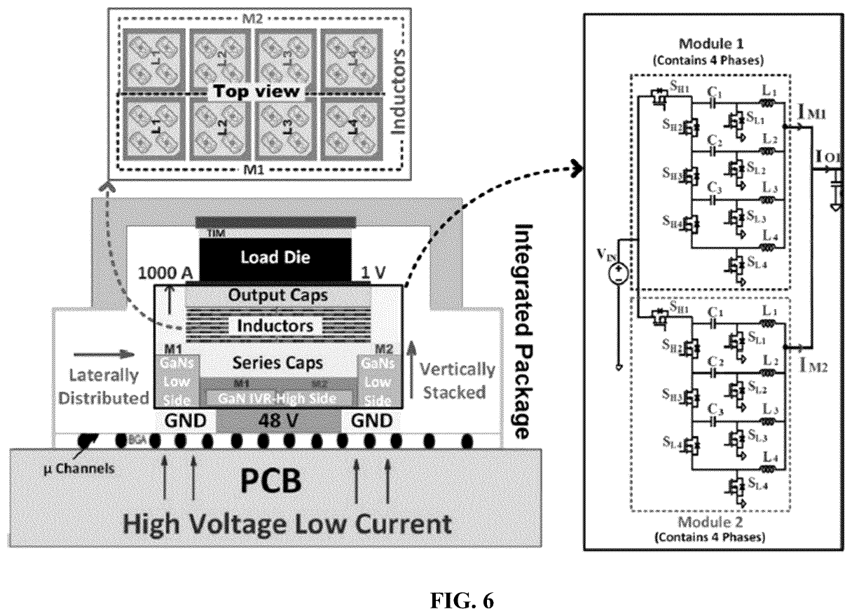

FIG. 6 illustrates an integrated package for an embodiment of the circuit. More specifically, FIG. 6 shows a package power delivery architecture using introduced IVR structure with embedded inductor networks at CCM/DCM boundary. The minimal required inductance for the exemplary structure can be strategically distributed across vertically stacked layers, accommodating 40 to 60 inductors per phase, each measuring 2.5 mm×2.5 mm (with four laterally distributed inductors per layer). These inductors can support up to 5A and 10 MHz, effectively reducing conduction losses. In a two-module and 4-phase architecture (totaling 8 phases), the total inductance per phase measures 2.5-nH and 0.65-nH respectively for switching frequencies of 1-MHz and 4-MHz. This facilitates efficient interleaving of phases and parallel modules, diminishing output current ripple and decreasing dependence on large capacitors, thereby enhancing the system's performance.

As can be appreciated, embodiments can be used to develop a System on Package (SOP) vertical power delivery architecture capable of delivering high power (1-kW) from the Printed Circuit Board (PCB) to Point of Load (POL) at a high current density and PCB-to-POL efficiency. The embedded inductors, laterally distributed and vertically stacked.

### Limitations of Current Technology and Proposed Advancements.

The practical implementation of embedded inductors with lateral distribution and vertical stacking, aiming to achieve high current density up to 2 A/mm², presents significant challenges. Furthermore, integrating GaN FET directly into the substrate emerges as a crucial advancement. This integration not only augments power density but also reduces the package size.

### Example 2

This example relates to a study to investigate a package power delivery architecture for high-performance computing (HPC), incorporating an embodiment of a modular multi-phase integrated voltage regulator (IVR). The 1-kW 48/1 V and 12/1 V architectures integrate an efficient interleaved buck-derived converter at the continuous-discontinuous boundary condition, facilitating parallel-connected networks of embedded inductors to deliver hundreds of amperes per phase. Due to the increased duty cycle and zero switching losses provided for the high side switch, the converter's frequency can be further increased up to 50 MHz with 8 parallel phases and 100 MHz with 16 parallel phases for a 48/1 V, 1 kW architecture. A conceptual 3-D stacked architecture using stacked glass substrates with flip chip GaN switches and embedded inductors, and capacitors is presented, offering a high-density single-stage 48-12/1 V IVR for the next generation of data center applications.

The demand for AI and high-performance computing (HPC) systems has driven advances in more powerful Graphic processing units (GPUs) and specialized AI accelerators in data centers. However, this progress comes at the cost of increased energy consumption, as data centers currently account for approximately 2% of total energy consumption in the United States. Improving power delivery network (PDNs) efficiency in data centers is one of the critical areas that needs attention.

Within the power delivery network (PDN) of data centers, the central processing units (CPUs) draw power from 48 V rails. This 48 V is protected by an uninterrupted power supply (UPS) to ensure continuous operation during power failures, where it undergoes conversion to the processor voltage through multiple-stage converters. Beyond the specific losses and efficiency issues associated with multiple stages of converters, the connectors, and cables between the power supply unit (PSU) or server racks and the motherboard, as well as copper routing between down-conversion stages, can significantly impact the overall efficiency of the power delivery network. Because the DC resistance Joule heating routing losses scale quadratically with current, the routing losses in the path from the last DC-DC converter, which is a voltage regulator module (VRM), dominate due to the low voltage and high current. This dominance has a detrimental effect on the overall system efficiency, especially at higher power levels. The main strategy to alleviate the routing's DC resistance is to increase the number of power layers on the printed circuit board (PCB), integrate more power pins, and utilize thicker power planes, which leads to the reduced power density.

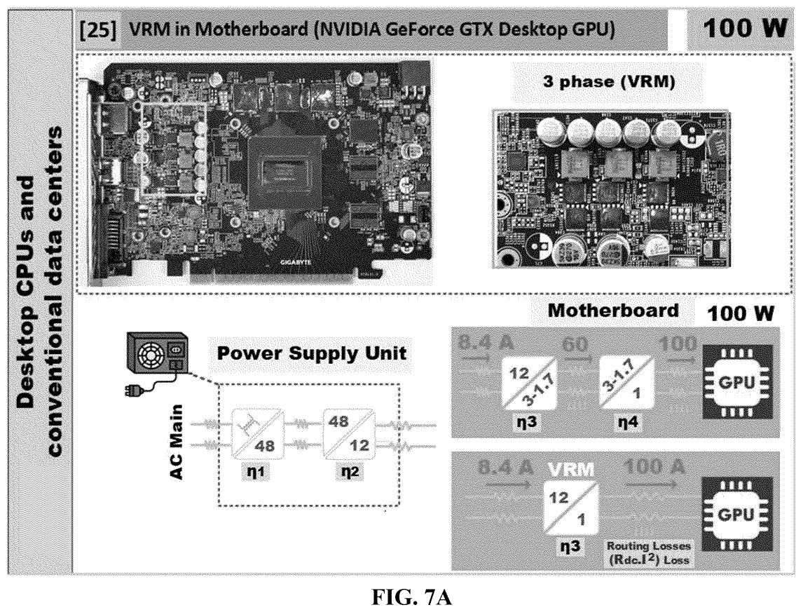

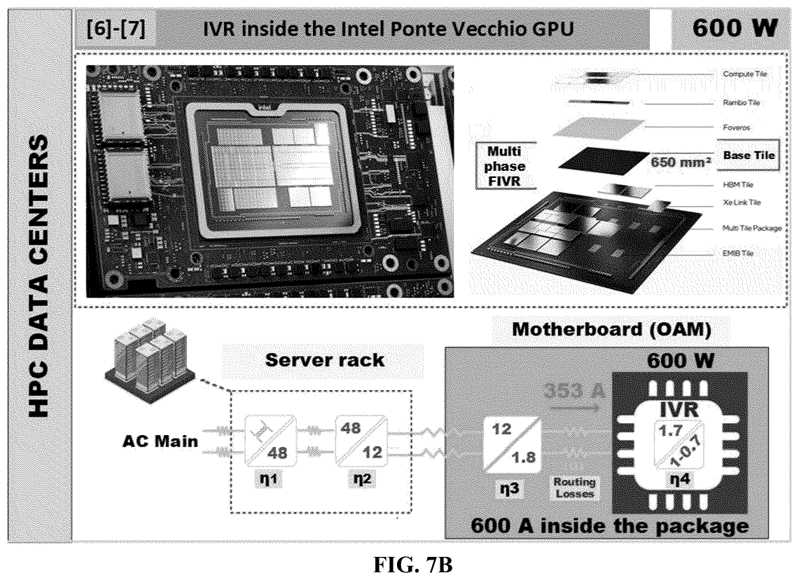

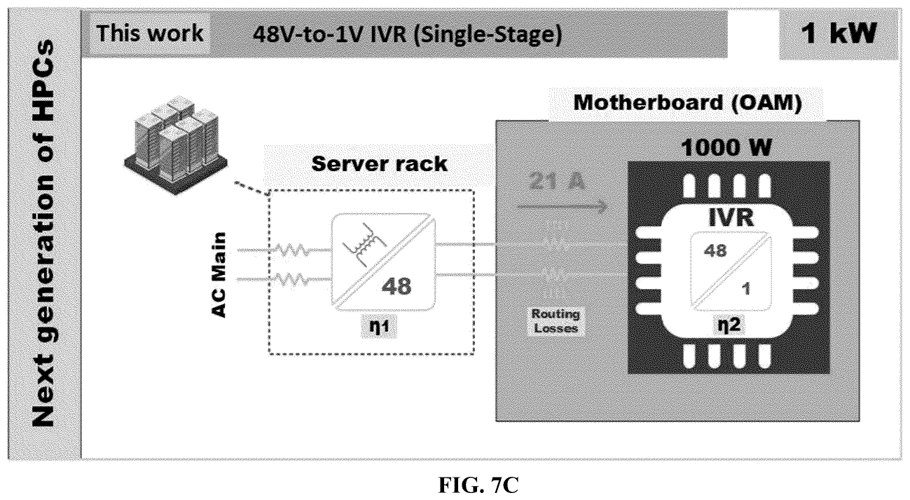

FIGS. 7A, 7B, and 7C illustrate various power delivery configurations for high-performance computing systems (HPCs). The traditional configuration for desktop computers and conventional data centers is depicted in FIG. 1a [5]. In this setup, a portion of the power delivery network, including the VRM modules, is placed on the motherboard close to the system-on-chip (SoC) load and is supplied by previous down-stage converters. Maintaining these architectures with increased power and required load current results in low power density and elevated routing losses.

System on Package (SOP) solutions present innovative processors design approaches by integrating heterogeneous technologies (2.5D and 3D). Using this technology, multiple chiplets at different technology nodes, including computing chips, cache, and High Bandwidth Memories (HBM), along with a part of the power delivery network, can be integrated into a single package. In February 2022, Intel unveiled its upcoming 7 nm heterogenous 3D processor called Ponte Vecchio, consisting of 47 chiplets with different technology nodes and 600 W total processing power. It is designed to power the Aurora supercomputer and capable of performing billions-billions of high-precision floating-point calculations per second. In this multi-die GPU, 1.7/1-0.7 V Fully Integrated VRMs (FIVRs) are embedded inside two chiplets referred to as base die with 3D stacked architecture and 140 MHz switching frequency, (see FIG. 7B). For this GPU, instead of delivering 600 A current via PCB routings, FIVRs directly powers the chiplets inside the GPU package up to total of 600 W (see FIG. 7B). The peak efficiency of these 3D-stackcd FIVRs is
0.86%, only marginally less than 1% lower than that of the monolithic IVRs. This 3D-stacked architecture achieves a notable reduction in input current by approximately 60% and minimizes routing losses by an impressive 85%. Furthermore, a cutting-edge in-package substrate inductor technology, known as Coaxial Magnetic Integrated Inductor (CoaxMIL), is implemented to replace air core inductors. The inductance with this composite core measures 2.5 nH, boasting an 8 A peak current capacity and a 12 m DC resistance.

In FIG. 7, power delivery architectures for HPCs (FIG. 7A)) Gigabyte GeForce GTX 1650 (100 W), using 3 down conversion stages where VRM is placed on the motherboard. Application for desktop computers is show in FIG. 7B: INTEL Ponte Vecchio GPU (600 W), using multiple stages of converters where VRM is integrated in the GPU. Application for high power HPC data centers is shown in FIG. 7C: integrated 48-12/1 V IVR inside the processor's package with negligible routing losses for the next generation of HPCs. While the presented approach in FIG. 7B successfully mitigates routing losses associated with the VRM stage, challenges persist in addressing high routing losses for the 12/1.8 V down conversion stage. This concern may exacerbate in the next generation of GPUs and HPCs, where power levels could escalate to 1 kW at a 0.7-1 V SoC load. Moreover, similar to the traditional architecture shown in FIG. 7A, the overall PDN efficiency of the product of several conversion steps remains low, leading to a lower overall efficiency.

A viable approach involves utilizing single stage integrated voltage regulators (IVRs) with an input voltage greater than 5 V. This approach mitigates the need for multiple down-conversion stages and reduces parasitic losses in the PDN, particularly routing loss. It has been demonstrated that compared to an IVR with an input voltage of 1.7 V (see FIG. 7B), an IVR with a 5 V input voltage reduces routing losses from 15% of output power to less than 2%, a reduction of over seven times. This reduction in routing losses increases to over 40 times for an input voltage of 12 V. Furthermore, elevating the input voltage of IVRs up to 48 V, the maximum available voltage in data center racks, results in negligible routing loss and also higher power density.

Achieving this is feasible by employing a single-stage or two-stage 48/1 V IVR. However, a 48/1 V IVR poses multiple challenges for practical use, such as an extremely small duly cycle, leading to ultra-short on-limes of high-side (HS) switches. This limitation restricts the switching frequency and prohibits the use of embedded inductors, preventing the reduction of system volume. For example, in a 1.7/1 V synchronous buck converter in the Ponte Vecchio IVR GPU (FIG. 7B), the duty cycle of the high-side switch should be ˜60%, resulting in an on-time of the switch (Tₒₙ) of ˜4.3 ns. In the case of using the same converter topology, this value decreases to ˜600 ps and ˜150 ps, respectively, for 12 V and 48 V input voltages. This narrow on-time is already lower than the rise time and fall time of existing power switches due to relatively high gate-source capacitances. Additionally, using smaller duty cycles imposes higher peak voltage and root mean square (rms) current for the HS switch, resulting in increased switching and conduction losses, as well as significant inductor losses.

To overcome the challenge of lower switching frequencies associated with higher input voltages, namely 48 V in heterogeneous integrated voltage converters, researchers have turned to high step-down converters using flying and series capacitors to increase the duty cycle and maximize the on-time of the HS switch. Such topologies are divided into three main categories: buck and modified buck topologies, switched-capacitor-based hybrid topologies, and merged two-stage hybrid topologies. While these converters extend the duty cycle and can exceed frequencies of 2 MHz, they are intentionally kept below a 5 MHz switching frequency to minimize switching losses for 48:1 or 12:1 conversion ratio. In System on Package (SOP) solutions, converters must operate within a 10-200 MHz frequency range to minimize inductance and the size of inductor packages, facilitating smooth integration with switching devices. This limitation arises from the constraints of embedded inductors, with a maximum inductance of 600-900 nH and peak currents of 8 A for magnetic cores, while air core embedded inductors are limited to 10 nH and 20 A peak current.

To address the aforementioned challenges of high switching losses, limited switching frequency, and the constrained inductance value of embedded inductors, exemplary embodiments provide for a novel modular high step-down converter for 48/1 V and 12/1 V integrated voltage regulator modules with zero switching losses and a small, required inductance value. This multi-phase and modular architecture can operate at the boundary of continuous-discontinuous conduction mode (CCM-DCM) conditions. This approach can efficiently discharge the switches' output capacitance during the off phase, eliminating switching losses and allowing for higher frequencies with wide-bandgap power transistors and small inductance values in the range of pico- and nanohenries.

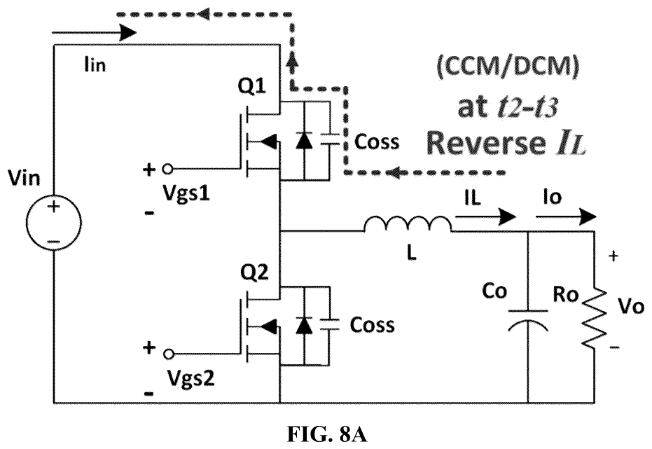

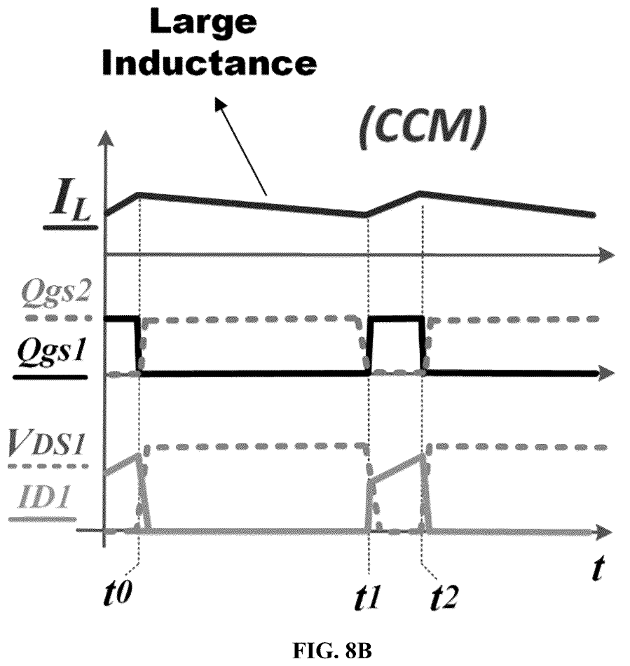

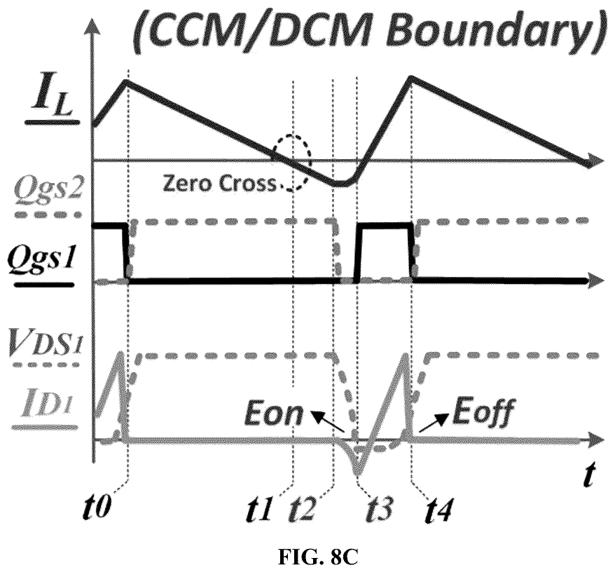

FIGS. 8A, 8B, and 8C show a comparison of a synchronous buck converter at the boundary of CCM/DCM vs. CCM condition to demonstrate zero switching losses and smaller required inductance.

CCM buck converter vs. CCM/DCM boundary condition.

Continuous Conduction Mode (CCM) buck converters and their derivatives have been widely employed as fundamental components of voltage regulator modules (see FIGS. 8A and 8B). The primary rationale for opting for CCM operation lies in the low ripple current of the output inductor, thereby reducing the need for a large output capacitance and lowering the ripple current for semiconductor components. However, for very low power applications, where the output current is in the range of milliamperes, it is practical to utilize buck converters in discontinuous conduction mode (DCM) or at the CCM/DCM boundary.

Intel introduced a FIVR based on DCM operation with a maximum current of 0.5 A, an input voltage of 2 V, and a load voltage of 0.7-1.2 V. This regulator is implemented in 14 nm CMOS with a 2.5 nH air-core inductor embedded in the package. Their FIVR features 88% practical peak efficiency with almost zero switching losses (soft-switching) and digitally controlled variable ON-time DCM operation up to 70 MHz.

Although utilizing the DCM operation has multiple advantages, it introduces very high ripple current and necessitates large capacitors to regulate the output voltage. Detecting the zero-crossing of the inductor current swiftly and accurately poses an additional obstacle to achieving efficient DCM operation at high switching frequencies. In FIGS. 8A-8C, the buck converter operation at CC/DCM boundary as well as CCM is illustrated. In a CCM buck converter, once the low side switch (Q₂) turns off, the high side switch (Q₁) turns on, and the switch current jumps into the inductor current (I_{L}), resulting in an overlap between the voltage and current of the switch at turn-on instants (see FIG. 8B). Additionally, when Q₁ turns on, the inherent output capacitance of the switch (Cₒₛₛ) discharges into the switch. These losses are known as switching losses, which are directly related to the frequency of the switch (f_{sw}). Unlike the CCM buck converter, the CCM/DCM boundary condition can provide zero switching losses at turn-on and reduced switching losses at turn-off. As shown in FIG. 8C, when the switch Q₁ turns off and Q₂ turns on, the inductor current reduces to zero due to the small inductance value and passes the zero-cross point at t₁. During the duration from t₁ to t₂, Q₂ keeps turning on for a short period, causing the output inductor to charge in a negative direction through C₀ and Q₂. With negative I_{L} at t₂, Q₂ turns off, and the small I_{L} reverse current passes through the C_{OSS} of the high side switch, discharging it into the input source. Once the drain-source voltage of Q₁ reaches zero, Q₁ can turn on with zero overlap between the voltage and current of the switch, as shown in FIG. 8C.

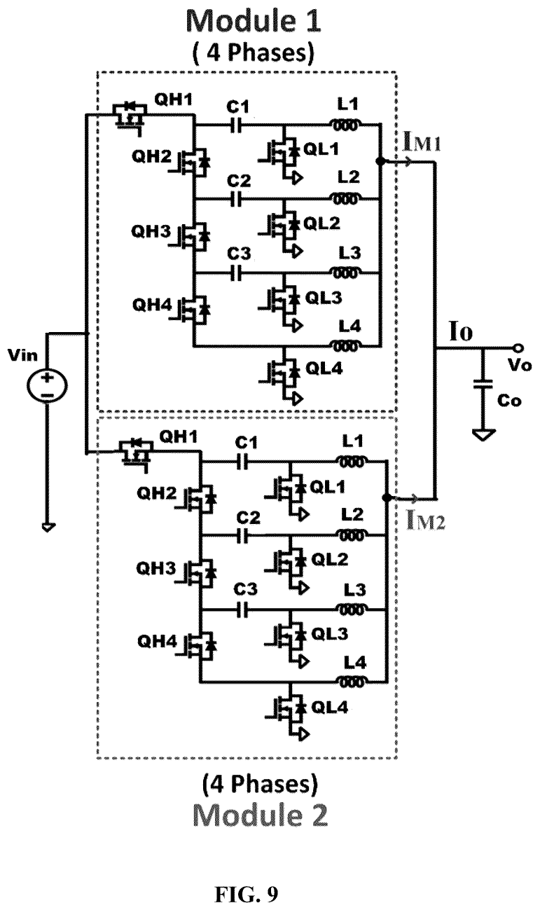

FIG. 9 shows an exemplary multi-phase high step-down series capacitor (SC) buck converter with zero turn-on switching losses at the CCM/DCM boundary condition.

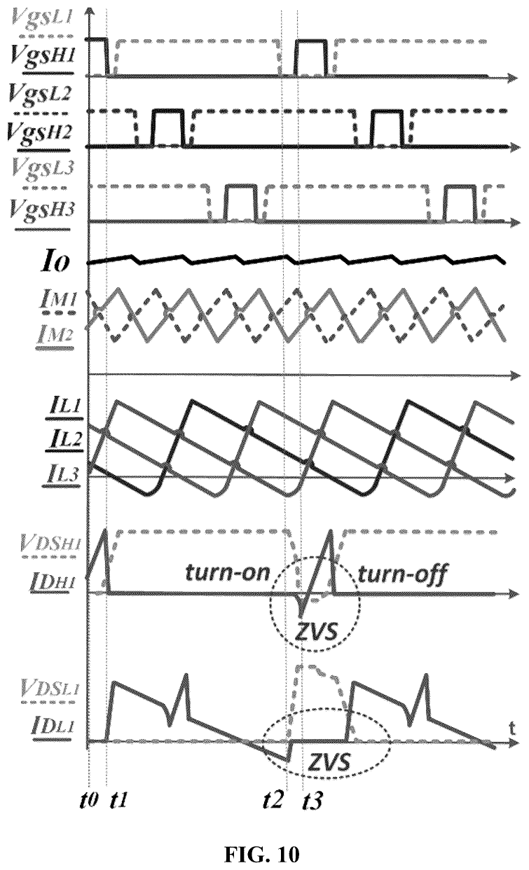

FIG. 10 shows theoretical key waveforms of an exemplary multi-phase converter at CCM/DCM boundary condition.

Table 1 show an analysis of the proposed converter for 1 kW, 48/1 V configurations,

with different numbers of phases and modules.

TABLE 1
Analysis of the proposed converter for 1 kW, 48/1 V configurations,
with different numbers of phases and modules

| | | | Power | | | | | | | | | | | | |
|---|---|---|---|---|---|---|---|---|---|---|---|---|---|---|---|
| Param- | | No. | Per | | High Side Switch | | | | | Inductance | | | | | I_{L}_Peak |
| eter | No. | Mod- | Mod- | Duty | On-time (Tₒₘ) (s) | | | | | Per Phase (nH) (Lcrit) | | | | | Per |
| Theo- | Phase | ule | ule(w) | cycle | Switching Frequency (MHz) | | | | | Switching Frequency (MHz) | | | | | phase (A) |
| retical Formula | nₚ | n_{M} | $\frac{{P}_{o}}{{n}_{M}}$ | $\frac{{n}_{P} {V}_{o}}{{V}_{in}}$ | 1 | 5 | 10 | 50 | 100 | 1 | 5 | 10 | 50 | 100 | $\frac{2 {I}_{o}}{{n}_{P} \times {n}_{M}}$ |
| Numer- | 4 | 2 | 500 | 8.4% | 83.4 ns | 16.7 | 8.4 | 1.7 | 840 | 6.72 | 1.34 | 0.68 | 0.14 | 70 p | 250 |
| ical | | 4 | 250 | | | ns | ns | ns | ps | 13.44 | 2.68 | 1.34 | 0.28 | 0.14 | 125 |
| Calcu- | | 8 | 125 | | | | | | | 26.9 | 5.4 | 2.68 | 0.54 | 0.27 | 62.5 |
| lation | | 16 | 62.5 | | | | | | | 53.76 | 10.7 | 5.4 | 1.1 | 0.55 | 31.25 |
| | | 32 | 31.3 | | | | | | | 107.5 | 21.5 | 10.7 | 2.1 | 1.1 | 15.6 |
| | | 64 | 15.7 | | | | | | | 215 | 43 | 21.5 | 4.3 | 2.2 | 7.8 |
| | 6 | 2 | 500 | 12.5% | 125 ns | 25 | 12.5 | 2.5 | 1.3 | 10.5 | 2.1 | 1.05 | 0.22 | 0.11 | 167 |
| | | 4 | 250 | | | ns | ns | ns | ns | 21 | 4.2 | 2.1 | 0.42 | 0.21 | 83.4 |
| | | 8 | 125 | | | | | | | 42 | 8.4 | 4.2 | 0.84 | 0.42 | 41.7 |
| | | 16 | 62.5 | | | | | | | 84 | 16.8 | 8.4 | 1.68 | 0.84 | 20.8 |
| | | 32 | 31.3 | | | | | | | 168 | 33.6 | 16.8 | 3.36 | 1.68 | 10.4 |
| | | 64 | 15.7 | | | | | | | 336 | 67.2 | 33.6 | 6.7 | 3.35 | 5.2 |

Exemplary topology of an IVR.

To increase the duty cycle, achieve zero switching losses, and operate at higher switching frequencies for 48-12/1V JVRs, the embodiments of the converter can adopt a multi-phase series capacitor (SC) buck structure at the CCM/DCM boundary condition for all inductors. An exemplary structure, illustrated in FIG. 10, employs interleaved phases and modules to deliver CCM output current to the output capacitor, while the inductor current operates under DCM boundary conditions. This exemplary approach differs from the conventional buck at the CCM/DCM boundary, which introduces significant output current ripple on the output capacitance. The primary challenge in utilizing DCM inductor current with series capacitors lies in maintaining charge balance among the series capacitors and achieving current sharing between interleaved phases and modules. Due to the merging operation between each two adjacent phases, each series capacitor (C₁, C₂, C₃) charges through the inductor of the same phase and discharges through the inductor current of its adjacent phase, ensuring an Amp-Sec balance for the series capacitors. This exemplary architecture features parallel modules denoted as n_{M} with phase shift (interleaving) to reduce output current ripple and simultaneously increase the output power up to 1 kW. Additionally, each module is constructed from interleaved phases, represented as nₚ. Notably, in this converter, the duty cycle of the high-side switches is correlated with the number of phases (nₚ). Consequently, increasing the number of phases enables a larger duty cycle and higher achievable frequencies. The relationship between duty cycle (D), number of phases (nₚ), output voltage (V₀), and input voltage (Vᵢₙ) is expressed by:

$$D = \frac{{n}_{P} \times {V}_{o}}{{V}_{i n}} \qquad ( 2 )$$

For analytical purposes, a 4-phases converter with two interleaved modules is considered (see FIG. 9). In this exemplary embodiment, all high-side switches (Q_{H}) have the same switching frequency (f_{sw}) and duty cycles (D). This holds true for the low-side switches (Q_{L}). In this exemplary multi-phase architecture, each phase undergoes three main time intervals, resulting in a total of (3nₚ) time intervals. The following discussion involves an explanation of the operation during these intervals for the first phase, with identical operations occurring for the subsequent phases.

First interval (t₀, t₁): Q_{H1}, the lop-side switch of phase 1, and Qₛ₂, the low-side switch from phase 2, conduct during this interval. As illustrated in FIG. 10, inductor L₁ charges through Vᵢₙ, Q_{H1}, C₁, and C₀ capacitor, with its current reaching up to two times the inductor average current due to tire boundary condition. The peak current of each inductor (I_{L}, pk) is given by

$${I}_{L} , p k = \frac{2 {I}_{o}}{{n}_{P} \times {n}_{M}} \qquad ( 3 )$$

Therefore, by increasing the number of phases and modules the inductors peak current can be reduced.

Second interval (t₁, t₂): Q_{H1} turns off, reducing the overlap between voltage and current of the switch due to the inherent output capacitance (C_{OSS}) of Q_{H1}, resulting in very low switching losses at turn-off time. Adding an extra nano-farad capacitor in parallel with the inherent output capacitor further reduces this overlap, minimizing losses. While charging C_{OSS}, I_{L1} current starts discharging the output capacitance of Q_{L1}, and this switch can be turned on with zero switching losses.

Table 2 shows a comparison of different embedded and in-package inductors for high frequency IVR applications.

TABLE 2
Comparison of different embedded and in-package
inductors for high frequency IVR applications.

| | | | Inductance / | Iₚₑₐₖ / | | |
|---|---|---|---|---|---|---|
| Ref. | Design | Core | R_{DC} (Ω) | Frequency | FOM | |
| [13] | PCB | Air | 685 nH/.7 m | 1 A/MHz | 1.37 | W |
| [10] | Spiral | MPC | 20-500 nH/13.6-39.3 m | 5 A/1-10 MHz | 15.1 | W |
| [14] | — | Thin film | 20 nH/9 m | 1 A/100 MHz | 2 | W |
| [11] | 3DL FIVR | Air | 2.5 nH/40.7 m | 5 A/140 MHz | 17.5 | W |
| [15] | 3d info | Air | 2.5 nH/12 m | 8 A/90 MHz | 14.4 | W |
| [16] | Substrate | Air | 1.2 nH/7.1 m | 0.6 A/140 MHz | 60 | mW |
| [17] | substrate | Air | 1.2 nH/7 m | 8 A/140 MHz | 10.75 | W |
| [18] | strip-line | Composite | 3 nH/12 m | 4 A/100 MHz | 4.8 | W |
| [8] | CoaxMIL | Composite | 2.5 nH/12 m | 8 A/90 MHz | 14.4 | W |
| [10] | Toroid | composite | 480 nH/23 m | 0.1 A/1 MHz | 4.8 | mW |
| [19] | Toroid | composite | 420 nH/89 m | 2.5 A/1 MHz | 2.6 | W |
| [13] | Spiral | MPC | 685 nH/40.7 m | —/2 MHz | — | |
| [20] | Spiral | Fe composite | 150 nH/205 m | 1/16 MHz | 2.4 | W |
| [21] | Toroid | Ni—Zn composite | 112 nH/265 m | 1.6 A/12 MHz | 3.44 | W |
| [22] | Solenoid | Thin film | 75 nH/270 m | 0.4 A/10 Hz | 0.12 | W |
| [23] | Toroid | Fe composite | 925 nH/66 m | 5 A/2 MHz | 46.2 | W |

Third interval (t₂, t₃): At the end of interval two, L₁ inductor current reaches zero and starts increasing in a negative direction. When the inductor current at t₂ reaches 1-2% of the peak current in the negative direction, Q_{L1} turns off under zero switching losses. The inductor current then passes in a reverse direction through the output capacitance of the high-side switch (Q_{H1}), discharging it into the input source. This results in zero capacitive turn-on loss of the high-side switch at turn-on. At t₃, Q_{H1} turns on with zero overlap between voltage and current, achieving zero switching losses. This zero-voltage switching (ZVS), named as soft-switching operation, occurs for all phases of the converter.

Optimization of converter phases and modules.

There are multiple possibilities for the configuration of 48/1 or 12/1 V, 1 kW IVR in terms of the number of interleaved phases and modules, each with different limitations on the switching frequency, the inductance value and the peak current of semiconductor and magnetic components, which requires doing optimization analysis to find the best approach for system on package solution (SoC).

In terms of the proposed IVR switching frequency, due to the zero turn-on losses and very low turn off losses, for both high side and low side switches, there is almost no limitation to increase the frequency of this converter up to 100 MHz or more. However, there is a limitation on the power switches on their minimum on-time which can impact on the practical switching frequency of the converter. According to equation (4), the on-time duration of the high side switch (Tₒₙ) depends on the switching frequency (f_{sw}), input and output voltages and the number of phases utilized in each module.

$${T}_{on} = \frac{{n}_{P} \times {V}_{o}}{{f}_{sw} \times {V}_{i n}} \qquad ( 4 )$$

Various configurations of the proposed converter with 4, 6, 8, and 16 phases along with 2-64 parallel modules are investigated. Based on equation (4), by considering the minimum on time of the high side switch for the existing semiconductor power switches as 3.4 nano second, the frequency cannot be further than 25 MHz, with 4-phase, 48/1 V architecture. However, for 4-phase, 12/1 V IVR, this frequency can be increased up to 100 MHz. The minimum of 16 phases per module is required for 48/1 V conversion to be able to increase the switching frequency up to 100 MHz. With these requirements, there are configurations of the DCM converter in the tables presented herein that are impossible to achieve, considering 3.4 nano second minimum switch on-time.

Another important parameter that needs to be considered in choosing the optimum number of phases and modules is the inductance value. Equation 5 represents the critical inductance of the converter phases for providing zero switching losses.

$${L}_{Crit} = \frac{{n}_{P} \times {n}_{M} \times {V}_{o} ( 1 - \frac{{n}_{P} \times {V}_{o}}{{V}_{i n}} )}{2 {I}_{o} \times {f}_{s w}} \qquad ( 5 )$$

This value (L_{Crit}) guarantees the zero-cross point of the inductor current at the boundary condition. However, the actual inductance value should be selected 1-2% lower than L_{cit} to provide a small negative inductor current and thus zero switching losses. Additionally, by choosing higher phases and modules count, the inductor peak current and the inductance value can be reduced.

Integrated converter using embedded inductors and gallium-bitride (GaN) switches.

To integrate the exemplary converter into the processor's package, it is essential to consider the specifications of key components for the potential use of embedded elements. The following discission offers a brief review of embedded and in-package inductors, outlines requirements for on-chip inductors tailored to the converter, and addresses associated challenges, with a particular focus on the ripple current at the DCM boundary. Additionally, the total dimensions of required Gallium-Nitride (GaN) switches for a 4-phase architecture with different parallel modules (2-64) are estimated. This estimation is followed by an explanation of a concise conceptual 3-D stacked architecture using stacked glass substrates.

Analysis of the required embedded inductor and switches.

When it comes to integrating converters, the design of the inductor plays a crucial role. While incorporating the inductor filter into the package or substrate to reduce the volume of converters, it comes with several limitations, such as saturation current, peak current, and maximum inductance value constraints. These parameters become particularly significant for high-power switching converters. Table 2 compares embedded and in-package inductors with different core materials in terms of switching frequency, inductor peak current, DC resistances, and the Figure of Merit

$$( FOM = {Li}_{L}^{2} {f}_{sw} ) .$$

According to this table, when using air core inductors, the achievable inductance reduces, however it offers higher peak currents up to 10-20 A. For magnetic cores, inductance can be increased to hundreds of nanohenrys with a maximum peak current of 8 A, owing to core saturation limitations. The positive aspect of inductors with magnetic cores is their lower required winding turns, leading to lower R_{DC} losses. Taking these limitations into account, the DCM converter is analyzed for four phases with 2-64 modules. As depicted in Table 2, due to high currents, the converter necessitates multiple embedded inductors in parallel for each inductor. The number of parallel embedded inductors per phase (n_{Lemb}) and the required inductance value can be determined using the following equations:

$${n}_{L . emb} = \frac{2 {I}_{o}}{{n}_{M} \times {n}_{P} \times {I}_{p} ( em . )} \qquad ( 6 )$$

$${L}_{emb .} = \frac{{V}_{o} ( 1 - {n}_{P} \frac{{V}_{o}}{{V}_{i n}} )}{f \times {I}_{p} ( e m . )} \qquad ( 7 )$$

Table 3 shows an analysis of required embedded inductors and GaN switches for a 48/1 V, 1 kW IVR at 1, 5, and 10 MHz, focusing on a 3-D stacked architecture.

TABLE 3
Analysis of required embedded inductors and GaN switches for a 48/1 V,
1 kW IVR at 1, 5, and 10 MHz, focusing on a 3-D stacked architecture.

| | | | | | | | | | | | | | Switches |
|---|---|---|---|---|---|---|---|---|---|---|---|---|---|
| | | | | | | | | | | | | | Total |
| | | | | | | | | | | | | | dimension |
| | | | | | | | | | | | | | with |
| | | | | | | | | | High side/Low side switch parameters | | | | EPC |
| | | | | | | | | | using EPC-GaN Switches | | | | GaNs |
| Pa- | | | | No. | | | | | | No. | | No. | (no. |
| ram- | | | Power | parallel Embedded | | Single embedded inductor | | | | parallel | | parallel | Switch) × |
| eter | | No. | Per | Inductors per phase | | per phase (nH), | | | | HS | IQ- | LS | Length × |
| Theo- retical | No. Phase | Mod- ule | Mod- ule(w) | $( \frac{2 {I}_{o}}{{n}_{M} \times {n}_{P} \times {I}_{p} ( e m . )} )$ | | (Iₚ₍ₑₘ₎ = 5 A, 10 A) Switching frequency | | | IQ-Peak HS | switch per | Peak LS | switch Per | Width = Total |
| For- mula | nₚ | n_{M} | $\frac{{P}_{o}}{{n}_{M}}$ | Iₚ(em. ) = 5 A | Iₚ(em. ) = 10 A | 1 MHz | 5 MHz | 10 MHz | $( \frac{2 {I}_{o}}{{n}_{M} \times {n}_{P}} )$ | phase/ Type | $( \frac{3.2 {I}_{o}}{{n}_{M} \times {n}_{P}} )$ | phase/ Type | (mm²) |
| Nu- | 4 | 2 | 500 | 50 | 25 | 183 nH | 36.7 nH | 18.4 nH | 250 A | 3/ | 400 A | 5/ | 64*6.05* |
| mer- | | 4 | 250 | 25 | 13 | (Iₚ₍ₑₘ₎ = | (Iₚ₍ₑₘ₎ = | (Iₚ₍ₑₘ₎ = | 125 A | EPC2066 | 200 A | EPC2066 | 2.3 = |
| ical | | 8 | 125 | 12 | 6 | 5A) | 5A) | 5A) | | 2/ | | 3/ | 891 mm² |
| Calcu- | | 16 | 62.5 | 6 | 3 | 92 nH | 18.4 nH | 9.2 nH | 62.5 A | EPC2067 | 100 A | EPC2067 | 80*3.25* |
| lation | | 32 | 31.3 | 3 | 2 | (Iₚ₍ₑₘ₎ = | (Iₚ₍ₑₘ₎ = | (Iₚ₍ₑₘ₎ = | | 1/ | | 2/ | 2.85 = |
| | | 64 | 15.7 | 2 | 1 | 10A) | 10A) | 10A) | 31.2 A | EPC2067 | 50 A | EPC2067 | 741 mm² |
| | | | | | | | | | | 1/ | | 1/ | 96*3.25* |
| | | | | | | | | | 15.6 A | EPC7001 | 25 A | EPC7001 | 2.85 = |
| | | | | | | | | | | 1/ | | 1/ | 890 mm² |
| | | | | | | | | | 7.8 A | EPC2619 | 12.5 A | EPC2619 | 128*4.1* |
| | | | | | | | | | | 1/ | | 1/ | 1.6 = |
| | | | | | | | | | | EPC2212 | | EPC2212 | 840 mm² |
| | | | | | | | | | | | | | 256*2.5* |
| | | | | | | | | | | | | | 1.5 = |
| | | | | | | | | | | | | | 960 mm² |
| | | | | | | | | | | | | | 512*2.1* |
| | | | | | | | | | | | | | 1.6 = |
| | | | | | | | | | | | | | 1700 mm² |

Iₚ(em.) represents the peak current of the embedded inductors reported in Table 2. To analyze the required embedded inductor for different frequencies and various phase and module architectures Table 3 is presented. This table illustrates that for a 4-phase converter with 8 parallel modules, n_{Lemh} is 12, and the inductance of each embedded inductor equals 183 nH, 36.7 nH, and 18.4 nH, respectively, for switching frequencies of 1, 5, and 10 MHz. A peak current of 5 A is considered for Iₚ(emb.) in equations (6) and (7).

Among the embedded inductors detailed in Table 2, the MFC core (HBS1) in stands out as a favorable choice for the DCM converter, particularly at frequencies ranging from 1-10 MHz, given its saturation current exceeding 5 A. Nevertheless, in future studies, it is imperative to reassess the operation of these magnetic cores, considering the high ripple current associated with inductors. It is important to note that increasing the frequency up to 100 MHz opens up additional possibilities, including the utilization of air core inductors or exploring other magnetic materials with high saturation current. Such alternatives necessitate further in-depth analysis and consideration.

3-D stacked architecture embedding passive components and flip chip GaN Switches.

The semiconductor industry is pursuing advanced packaging technologies that enable higher interconnection density, wider bandwidth and lower loss, and 3-D stacking is an enchanting solution. Multi-substrate glass interposer provides a solution for 3-D stacking of chips from different processes and technologies, as it incorporates flexible chip assemblies and thermal managements, and brings dense and low-loss vertical interconnects.

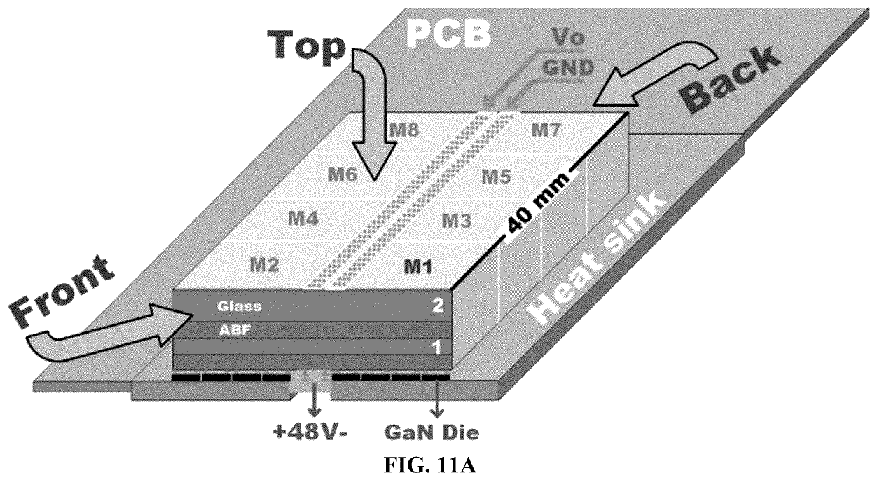

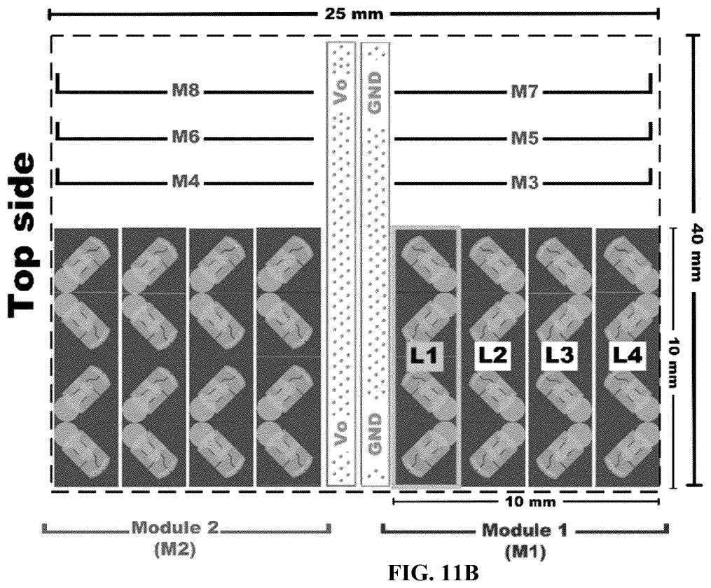

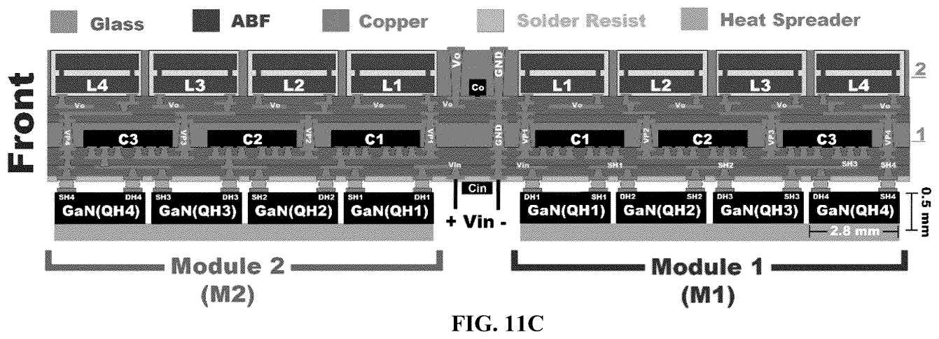

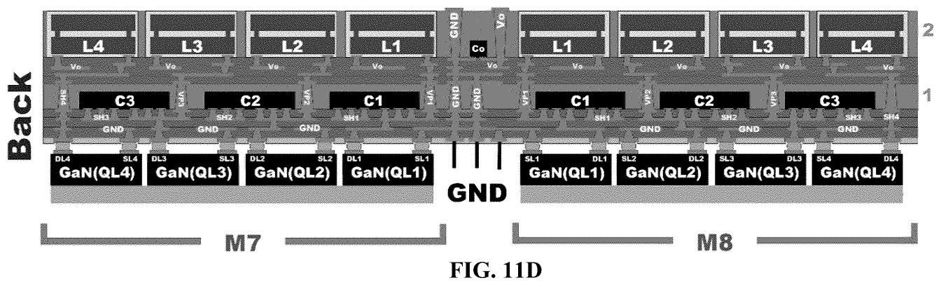

FIGS. 11A, 11B, 11C, and 11D present a conceptual 3-D stack architecture for an exemplary 48/1 V, 1 kW, 4-phase, 8-module structure, employing two glass substrates and multiple ABF layers for interconnections. In FIG. 11, a 3-D stacked power delivery architecture with an exemplary 4-phase, 8-module IVR (1 kW, 48/1 V) is shown for: (a) 3-D view, (b) top (c) front side, and (d) back side. In FIG. 11, modules are denoted as M1 to M8. In this exemplary design, high side switches (Q_{H1}-Q_{H4}) utilize a single EPC 2067 GaN switch, while low sided switches (Q_{LI}-Q_{L4}) employ two parallel switches, as detailed in Table 3. Series capacitors are integrated at the bottom of the lower glass substrate, and GaN chiplets are flip chipped beneath the capacitors using ABF layers. This configuration allows for the incorporation of a heat spreader or heat sink to mitigate GaN thermal issues. Within the second glass substrate, inductors and output capacitors are embedded. Note that as part of future optimization, we are considering adding inductors in the RDL layers to avoid glass to glass bonding.

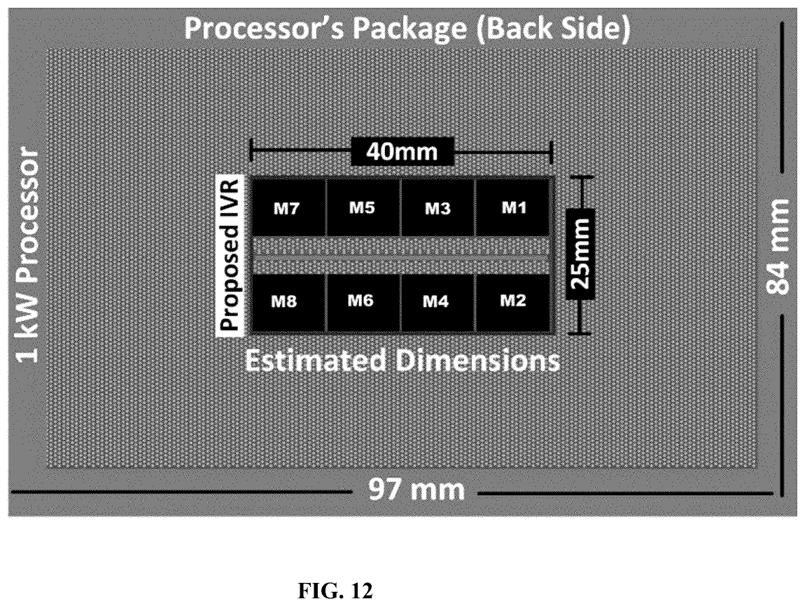

The size of the entire package is estimated using an array of inductors with MPC magnetic cores. Mutual inductance analysis for the inductor arrays at a 2.5 A current demonstrates no coupling between the inductors. According to Table. 3, for the 4-phase, 8-module architecture, implementing at least 12 inductors is necessary and can be achieved through 4 arrays and 3 stacked layers. 3-dimensional view, top, front, and back, cross-sections are illustrated, respectively, in FIGS. 5A, 5B, 5C and 5D. By extrapolating from the package dimensions and power specifications of the Ponte Vecchio GPU, we determined an estimated size for a 1 kW processor. Subsequently, a comparison was drawn between the estimated dimensions of the processor and those of the proposed 1 kW, 48/1V IVR located at the center of the processor, as depicted in FIG. 12. FIG. 12 shows estimated dimension of an exemplary architecture using EPC GaN switches with 1 MHz switching frequency in comparison to the estimated package dimension of a 1 kW GPU. Increasing the switching frequency of the IVR to the range of 10-100 MHz holds substantial potential for significantly minimizing its overall dimension.

While this approach aims to achieve higher interconnection density, and lower loss through dense vertical interconnects, specific challenges arise from integrating various components into a single package. These challenges encompass thermal, mechanical, Electromagnetic Interferences (EMI), and reliability considerations, and addressing them will be a key focus in future work to enable the deployment of this power delivery solution in data center applications. The presence of two or more glass layers introduces reflections as signals traverse through-package vias (TPV) from one dielectric to another, resulting in loss and bandwidth reduction. Furthermore, multi-substrates amplify thermal stress on material interfaces due to the coefficient of thermal expansion (CTE) mismatch, potentially leading to deformation and delamination during thermal cycling. Additionally, the inherently low thermal conductivity of glass layers poses a challenge lor dissipating heat from high-power density chips. These challenges coherently exist with the increased stack-up layers and are hard to address individually. Thus, strategic choices in electrical, thermal, and mechanical co-designs are essential for overcoming the challenges posed by the heightened 3D chip stack-up, ensuring the functionality and durability of the advanced packaging system.

In this example, we introduced an exemplary 3-D stacked power delivery architecture designed for a 1 kW Processor. The core of our IVR incorporates an efficient multi-phase series capacitor (SC) buck converter, strategically eliminating switching losses at the CCM/DCM boundary. This innovative approach effectively addresses frequency limitations associated with 48-12/1 V IVRs, overcoming issues related to switching losses and limited turn-on time of power switches. Our analysis, encompassing configurations of 2-64 interleaved modules with 4-16 phases, indicates that a 4-phase architecture can achieve a maximum frequency of 25 MHz for 48/1 V conversion and 100 MHz for 12/1 V conversion. Incorporating a MPC core (HBS1) for embedded inductors in the 48/1 V architecture necessitates 12 parallel inductors, with values of 183 nH and 36.7 nH for 1 MHz and 5 MHz switching frequencies, respectively. The maximum dimensions of this inductor network, in 4 lateral and 3 stacked layers, would be 2.5 cm×10 cm×1.5 cm, reducible with higher frequencies and lower inductance values. The estimated dimensions for the 48/1 V, 1 kW package, with a. 1 MHz, 4-phase, 8-module setup, are approximately 40 cm (length), 25 cm (width), without considering GaN gate drivers. This includes 96 EPC2067 GaN switches, 32 package inductors (each housing 12 embedded inductors), and 24 embedded series capacitors. The exemplary 3-D stacked architecture with two glass substrates provides a 2.5 cm×10 cm space for high-voltage series capacitors within the lower glass substrate, presenting a promising area for future research. The use of flip chip GaN switches beneath the first substrate contributes to a low-profile architecture with minimal package thickness.

### Example 3

Embodiments relate to an integrated voltage regulator (IVR) module for high-performance computing (HPC) systems, featuring a modular multi-phase step-down series capacitor buck converter. Key advancements include enabling the use of pico and nano henry filter inductors, facilitating embedded inductor integration for package power delivery. The architecture enables soft switching, eliminating semiconductor switch losses, and supports increased duty cycles with up to 48V input voltages, allowing for switching frequencies of up to 100 MHz with interleaved modules. Efficient discharge of output capacitance during the off phase minimizes switching losses. Interleaving phases and modules enable high output currents up to 1 kA with voltage ratios of 48V-to −1V or 12V-to −1V @1 kW, enhancing power density for next-gen data center GPUs. The design transitions from PCB to a 3-D stacked packaged architecture, utilizing stacked glass substrates with flip chip gallium nitride (GaN) power transistors and embedded inductors and capacitors. This approach offers a high-density single-stage 48-12/1V IVR for future data center applications.

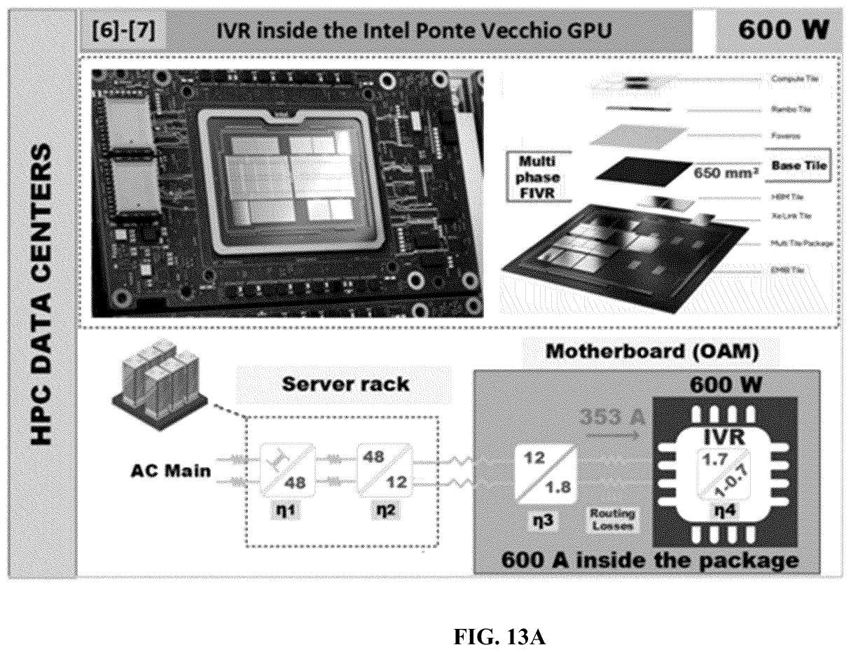

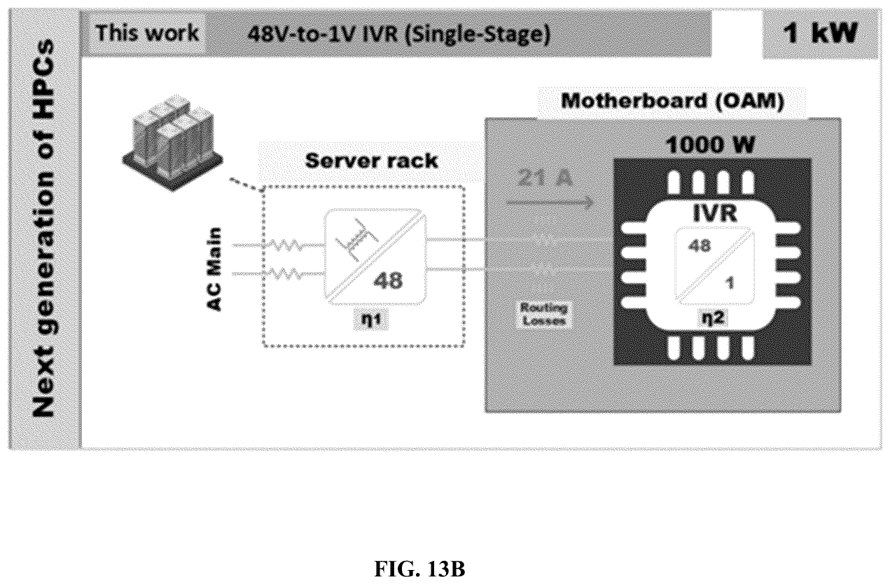

FIGS. 13A and 13B show power delivery architectures for the next generation of HPCs to reduce routing losses. FIG. 13A shows INTEL Ponte Vecchio GPU (600 W), using multiple stages of converters where VRM is integrated in the GPU. FIG. 13B shows this work: Integrated 48-12/1 V IVR inside the processor's package with negligible routing losses. The surge in AI and HPC requirements has led to advancements in potent Graphic processing units (GPUs) and AI accelerators in data centers. However, this has escalated energy usage, with data centers now consuming about 2% of total energy in the US. One of the main sections in data centers that has high losses and can improve efficiency is the power delivery network. The power from 48 V rails in the server racks or power supply unit (PSU) are transferred to the processes through the power delivery network (PDN). This includes multiple stage converters, connectors, and copper routing between down-conversion stages. Within the PDN, the last down conversion stage which is close to the processors is called Voltage Regulator Module (VRM), also known as a Processor Power Module (PPM), functions as a step-down DC-DC switching converter. It is comprised of high-frequency semiconductors and their control circuits, alongside passive filter components including capacitors and inductors. This module plays a crucial role in supplying the microprocessor and chipset with the necessary voltage, converting higher voltages like +1.7 V, +3.3 V, +5 V, or +12 V to lower voltages, typically around 1 V or even lower, as per the specific requirements of devices.

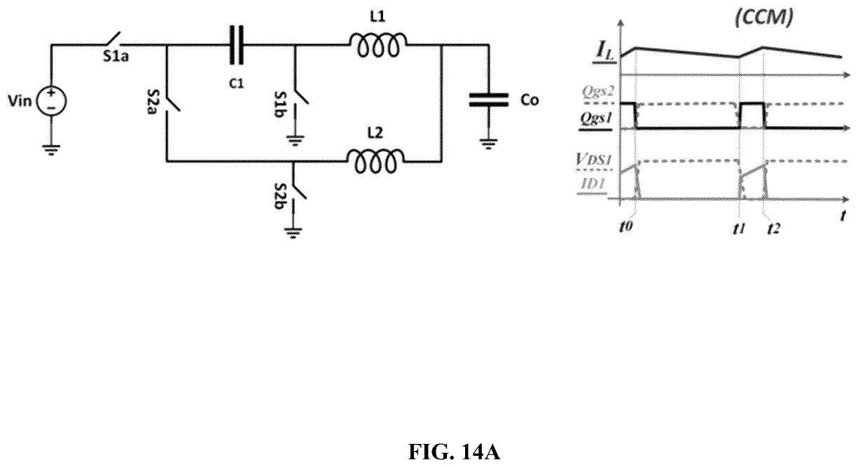

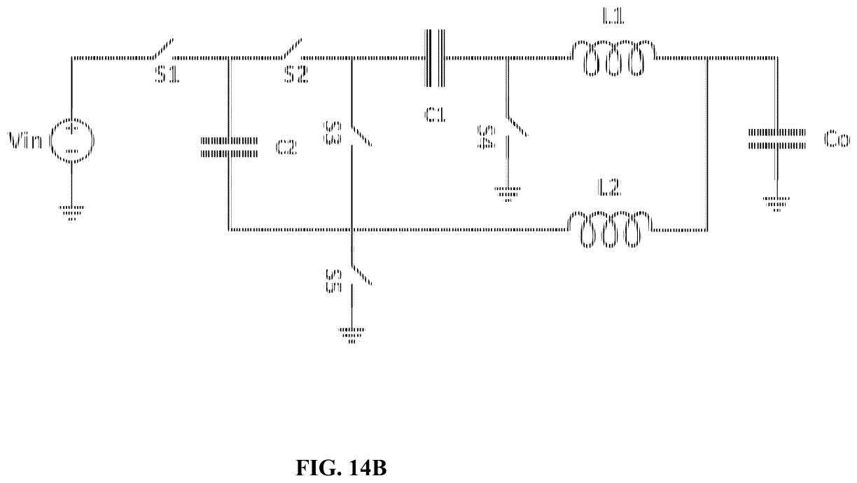

FIGS. 14A and 14B shows exemplary fundamental blocks of multi-phase step-down converters operating in continuous conduction mode (CCM) with (FIG. 14A) series capacitors and (FIG. 14B) flying capacitors, wherein CCM operation necessitates a relatively large inductance, with top-side switches experiencing switching losses. In the traditional power delivery configuration for desktop computers and conventional data centers, the VRM module is placed on the motherboard close to the system-on-chip (SoC) load and is supplied by previous down-stage converters. Beyond the specific losses and efficiency issues associated with multiple stages of converters in traditional PDNs, the connectors, and cables between the power supply unit (PSU) or server racks and the motherboard, as well as copper routing between down-conversion stages can significantly impact the overall efficiency of the power delivery network. Because the dc resistance Joule heating routing losses scale quadratically with current, the routing losses in the path from VRM dominate due to the low voltage and high current. This dominance has a detrimental effect on the overall system efficiency, especially at higher power levels.

FIGS. 13A-13B illustrate the improved power delivery configurations for high-performance computing systems (HPCs) to reduce routing losses. FIG. 13A shows the power delivery architecture in Ponte Vecchio heterogenous 3D processor that INTEL unveiled in February 2022, with 600 W total processing power. In this GPU, 1.7/1-0.7 V Fully Integrated VRMs (FIVRs) are embedded inside two chiplets with 3D stacked architecture and 140 MHz switching frequency, (see FIG. 13A). For this GPU, instead of delivering 600 A current via PCB routings, FIVRs directly powers the chiplets inside the GPU package up to a total of 600 W (FIG. 13A). This 3D-stacked architecture achieves a notable reduction in routing losses by 85%. While the presented approach in FIG. 13A successfully mitigates routing losses associated with the VRM stage, challenges persist in addressing high routing losses for the 12/1.8 V down conversion stage. This concern may exacerbate in the next generation of GPUs and HPCs, where power levels could escalate to 1 kW at a 0.7-1 V SoC load. Moreover, similar to the traditional power delivery architectures, in this architecture the overall PDN efficiency of the product of several conversion steps remains low as well, leading to a lower overall efficiency.

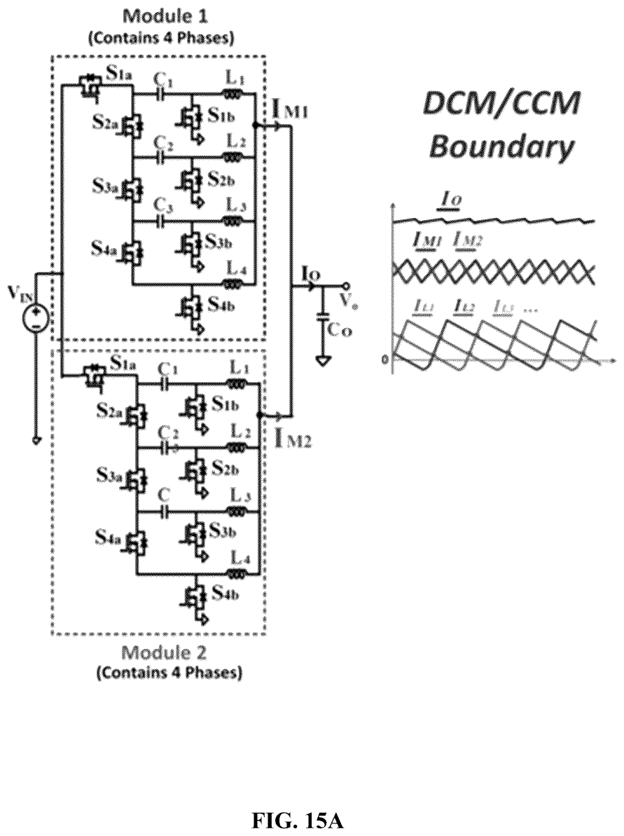

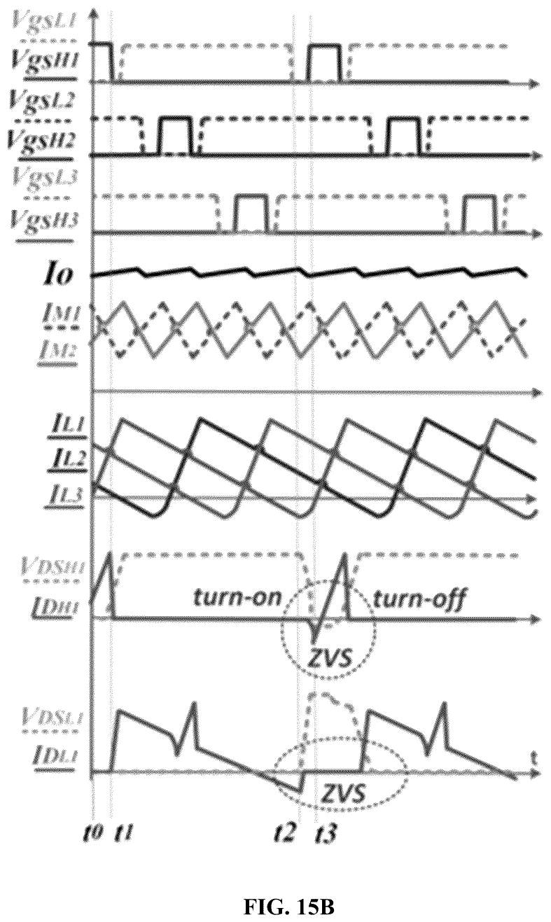

FIGS. 15A and 15B show an exemplary step-down series capacitor (SC) buck converter with zero turn-on switching losses at the CCM/DCM boundary condition utilizing relatively small inductances. FIG. 15A shows a converter with 4 interleaved phase and 2 interleaved modules to increase power and reduce inductor current ripple, and FIG. 15B shows theoretical key waveforms.

A viable approach involves utilizing single stage integrated voltage regulators (IVRs) with an input voltage greater than 5 V. This approach mitigates the need for multiple down-conversion stages and reduces parasitic losses in the PDN, particularly routing loss. In, it is demonstrated that compared to an IVR with an input voltage of 1.7 V, an IVR with a 5 V input voltage reduces routing losses from 15% of output power to less than 2%, a reduction of over seven times. This reduction in routing losses increases to over 40 times for an input voltage of 12 V. Furthermore, elevating the input voltage of IVRs up to 48 V, which is the maximum available voltage in data center racks, results in negligible routing loss and higher power density.

Achieving this is feasible by employing a single-stage or two-stage 48 V-to −1 V IVR. However, a 48/1 V IVR poses multiple challenges for practical use, such as an extremely small duty cycle, leading to ultra-short on-times of high-side (HS) switches. This limitation restricts the switching frequency and prohibits the use of embedded inductors, preventing the reduction of system volume. To overcome the challenge of lower switching frequencies associated with higher input voltages, researchers have turned to high step-down converters using flying and series capacitors to increase the duty cycle and maximize the on-time of the HS switch. In, these topologies are divided into three main categories: buck and modified buck topologies, switched-capacitor-based hybrid topologies, and merged two-stage hybrid topologies. While these converters extend the duty cycle and can exceed frequencies of 2 MHz, they are intentionally kept below a 5 MHz switching frequency to minimize switching losses for 48:1 or 12:1 conversion ratio. Meanwhile, in System on Package (SOP) solutions, converters must operate within a 10-200 MHz frequency range to minimize inductance and the size of inductor packages, and to facilitate smooth integration with switching devices.

The VRM architectures, including the converters in FIGS. 14A-14B, do exhibit switching losses, which are directly related to the switching frequency and consequently reduce total efficiency. This is one of the important reasons for limiting the operating frequency of VRMs with input voltages higher than five volts. As shown in FIG. 13B, to reduce routing losses in high-power VRMs, it is required to increase the input voltage of the VRM instead of using multiple converter stages. VRMs operate in Continuous Conduction Mode (CCM), where the inductor current of the output filter circuit never drops to zero. However, another mode called Discontinuous Conduction Mode (DCM) exists in step-down converters, where the inductor current falls to zero in a short period of time. DCM finds applications in specific scenarios, especially in low-current applications. In, Intel introduced a very low power integrated converter based on DCM operation with a maximum current of 0.5 A, an input voltage of 2 V, and a load voltage of 0.7-1.2 V. This regulator is implemented in 14 nm CMOS with almost zero switching losses (soft-switching) and digitally controlled variable ON-time DCM operation up to 70 MHz. However, this converter cannot be used for high-power and high-current applications like AI GPUs.

To address the aforementioned challenges of high switching losses, limited switching frequency, and the constrained inductance value of embedded inductors, this paper presents a novel soft-switching modular high step-down converter based on 48-12 V/1V 3D stacked package power delivery architecture using series capacitor building blocks and operating at the boundary of continuous-discontinuous conduction mode (CCM-DCM). This architecture provides zero turn-on switching losses, negligible power delivery routing losses and a small, required inductance value. This approach efficiently discharges the switches' output capacitance during the off phase, eliminating switching losses and allowing for higher frequencies with wide-bandgap power transistors and small inductance values in the range of pico- and nanohenries.

This converter can be designed with different number of phases and modules.

The power per module, maximum duty cycle of the high side switches, maximum switching frequency depending on n_{P}, the required inductance per-phase and the inductor peak current for different combinations of the converter are analyzed in Table 1. In terms of the proposed IVR switching frequency, due to the zero turn-on losses and very low turn off losses, for both high side and low side switches, there is almost no limitation to increase the frequency of this converter up to 100 MHz or more. However, there is a limitation on the power switches on their minimum on-time which can impact on the practical switching frequency of the converter. According to equation (10), the on-time duration of the high side switch (Tₒₙ) depends on the switching frequency (f_{sw}), input and output voltages and the number of phases utilized in each module.

$${T}_{on} = \frac{{n}_{P} \times {V}_{o}}{{f}_{sw} \times {V}_{i n}} \qquad ( 8 )$$

Based on equation 8 and considering the minimum on time of the high side switch for the existing semiconductor power switches as 3.4 nano second, the frequency cannot be further than 25 MHz, with 4-phase, 48/1 V architecture. However, for 4-phase, 12/1 V IVR, this frequency can be increased up to 100 MHz. The minimum of 16 phases per module is required for 48/1 V conversion to be able to increase the switching frequency up to 100 MHz.

The primary challenge in utilizing the inductor in this converter, which operates in DCM with series capacitors, lies in both maintaining charge balance among the series capacitors and achieving current sharing between interleaved phases and modules. Due to the merging operation between each two adjacent phases, each series capacitor (C₁, C₂, C₃) charges through the inductor of the same phase and discharges through the inductor current of its adjacent phase, ensuring an Amp-Sec balance for the series capacitors. This architecture features parallel modules denoted as n_{M} utilizing interleaving technique to reduce output current ripple and simultaneously increase the output power up to 1 kW. Additionally, each module is constructed from interleaved phases, represented as n_{P}. Notably, in this converter, the duty cycle of the high-side switches is correlated with the number of phases (nₚ). Consequently, increasing the number of phases enables a larger duty cycle and higher achievable frequencies. The relationship between duty cycle (D), number of phases (nₚ), output voltage (V₀), and input voltage (Vᵢₙ) is expressed by

$$D = \frac{{n}_{P} \times {V}_{o}}{{V}_{i n}} \qquad ( 9 )$$

For analytical purposes, a 4-phases converter with two interleaved modules is considered in (FIG. 15A) and the theorical key waveforms are shown in FIG. 15B. All high-side switches (Q_{H}) have the same switching frequency (f_{sw}) and duty cycles (D). This holds true for the low-side switches (Q_{L}). In this multi-phase architecture, each phase undergoes three main time intervals, resulting in a total of (3nₚ) time intervals. This paper focuses on explaining the operation during these intervals for the first phase, with identical operations occurring for the subsequent phases.

First interval (t₀, t₁): Q_{H1}, the top-side switch of phase 1, and Q_{S2}, the low-side switch from phase 2, conduct during this interval. As illustrated in FIG. 15B, inductor L₁ charges through Vᵢₙ, Q_{H1}, C₁, and C₀ capacitor, with its current reaching up to two times the inductor average current due to the boundary condition. The peak current of each inductor (I_{L}, pk) is given by

$${I}_{L} , p k = \frac{2 {I}_{o}}{{n}_{P} \times {n}_{M}} \qquad ( 10 )$$

Therefore, by increasing the number of phases and modules the inductors peak current can be reduced.

Second interval (t₁, t₂): Q_{H1} turns off, reducing the overlap between voltage and current of the switch due to the inherent output capacitance (C_{OSS}) of Q_{H1}, resulting in very low switching losses at turn-off time. Adding an extra nano-farad capacitor in parallel with the inherent output capacitor further reduces this overlap, minimizing losses. While charging C_{OSS}, I_{L1} current starts discharging the output capacitance of Q_{L1}, and this switch can be turned on with zero switching losses.

Third interval (t₂, t₃): At the end of interval two, L₁ inductor current reaches zero and starts increasing in a negative direction. When the inductor current at t₂ reaches 1-2% of the peak current in the negative direction, Q_{L1} turns off under zero switching losses. The inductor current then passes in a reverse direction through the output capacitance of the high-side switch (Q_{H1}), discharging it into the input source. This results in zero capacitive turn-on loss of the high-side switch at turn-on. At t₃, Q_{H1} turns on with zero overlap between voltage and current, achieving zero switching losses. This zero-voltage switching (ZVS), named as soft-switching operation, occurs for all phases of the converter.

The building block of the multi-phase VRM is presented in FIG. 2A to depict the precise operation of the top side switch and demonstrate the elimination of switching losses with the proposed converter. It shows the inductor current, gate-source and drain-source voltage of switches, and the top switch current all in the same figure. Unlike the CCM buck converter, the CCM/DCM boundary condition can yield zero switching losses at turn-on and reduced switching losses at turn-off. As shown in FIG. 2A, when the high side switch Q₁ turns off and low side switch Q₂ turns on, the inductor current reduces to zero due to the small inductance value and passes the zero-cross point at t₁. During the duration from t₁ to t₂, Q₂ keeps turning on for a short period, causing the output inductor to charge in a negative direction through C₀ and Q₂. With negative I_{L} at t₂, Q₂ turns off, and the small I_{L} reverse current passes through the C_{OSS} of the high side switch, discharging it into the input source. Once the drain-source voltage of Q₁ reaches zero, Q₁ can turn on with zero overlap between the voltage and current of the switch, as shown in FIG. 2A.

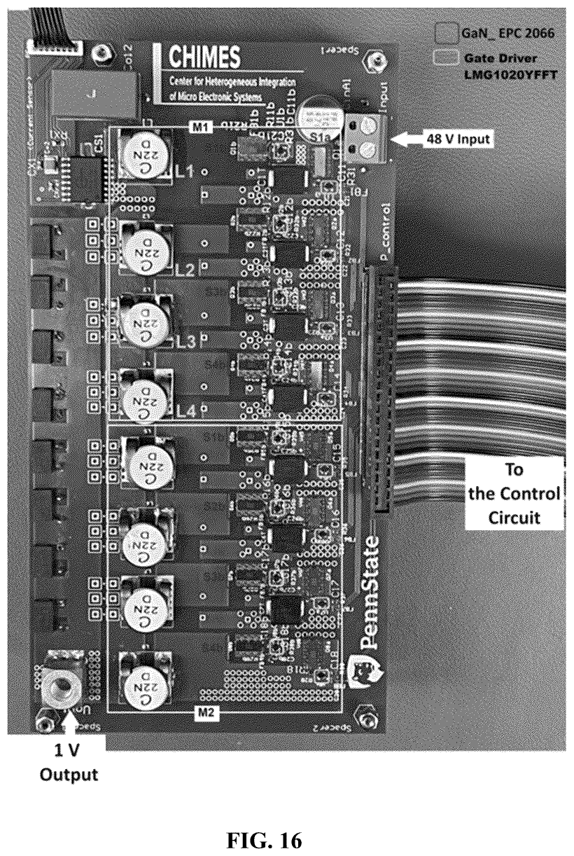

FIG. 16 shows an exemplary discrete version of the converter on printed circuit board (PCB) using EPC 2066 GaN Switches and Coilcraft air core inductors. (250 W, 48/1 V). FIG. 16 illustrates the implemented converter on printed circuit boards, each with a nominal power of 250 W (containing two modules M1 and M2), switching frequency of 1 MHz, and a voltage conversion ratio of 48-to −1. Every board incorporates two interleaved modules, each with 4 phases, and employs EPC 2066 GaN switches, LMG1020YFFT Texas Instrument gate drivers, and 22 nH air core inductors from Coilcraft. This prototype serves to validate the operation of the converter and acts as a steppingstone towards implementing the integrated version of the converter.

To implement the integrated version, the analysis begins with determining the required embedded inductors and GaN switches for a 48/1 V, 1 kW IVR at switching frequencies of 1, 5, and 10 MHz, each with 4 phases and 2-64 modules, as presented in Table 2. An important consideration in choosing the optimum number of phases and modules is the inductance value, which is addressed by Equation 11, representing the critical inductance of the converter phases for achieving zero switching losses:

$${L}_{Crit} = \frac{{n}_{P} \times {n}_{M} \times {V}_{o} ( 1 - \frac{{n}_{P} \times {V}_{o}}{{V}_{i n}} )}{2 {I}_{o} \times {f}_{s w}} \qquad ( 11 )$$

This value (L_{Crit}) guarantees the zero-cross point of the inductor current at the boundary condition. However, the actual inductance value should be selected 1-2% lower than L_{crit} to provide a small negative inductor current and thus zero switching losses. Additionally, by choosing higher phases and modules count, the inductor peak current and the inductance value can be reduced. While incorporating the inductor filter into the package or substrate can reduce the volume of converters, it comes with several limitations, such as saturation current, peak current, and maximum inductance value constraints. These parameters become particularly significant for high-power switching converters.

Specifically, for the package and embedded inductors unlike discrete magnetics, the peak current is limited to 8 A for magnetic core inductors and 10-20 A for air core inductors. Due to high currents, the converter necessitates multiple embedded inductors in parallel for each inductor. The number of parallel embedded inductors per phase (n_{L.emb}) and the required inductance value can be determined using the following equations:

$${n}_{L . emb} = \frac{2 {I}_{o}}{{n}_{M} \times {n}_{P} \times {I}_{p} ( em . )} \qquad ( 12 )$$

$${L}_{emb .} = \frac{{V}_{o} ( 1 - {n}_{P} \frac{{V}_{o}}{{V}_{i n}} )}{f \times {I}_{p} ( e m . )} \qquad ( 13 )$$

Iₚ(em.) represents the peak current of the embedded inductors.

This table illustrates that for a 4-phase converter with 8 parallel modules, n_{Lemb} is 12, and the inductance of each embedded inductor equals 183 nH, 36.7 nH, and 18.4 nH, respectively, for switching frequencies of 1, 5, and 10 MHz. A peak current of 5 A is considered for Iₚ(em.) in equations (12) and (13).

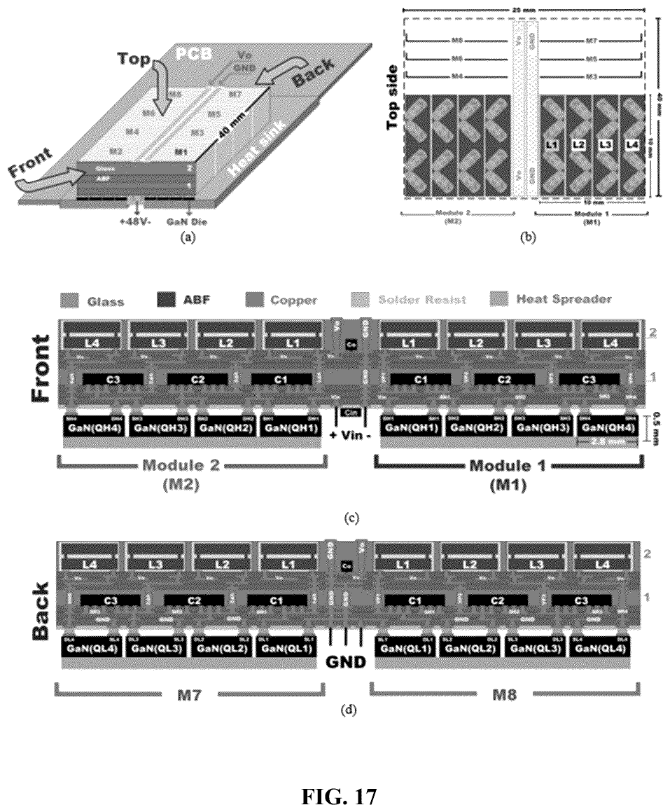

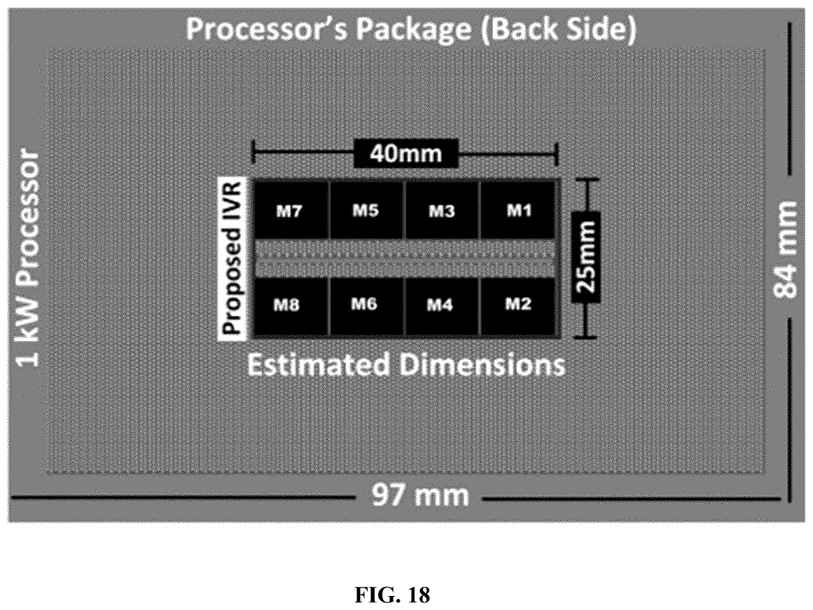

FIG. 17 (panels A, B, C, and D) show an exemplary 3-D stacked package power delivery architecture with the proposed 4-phase, 8-module IVR (1 kW, 48/1 V): (Panel A) 3-D view, (Panel B) top (Panel C) front side, and (Pane C) back side. FIG. 18 shows estimated dimension of the proposed architecture using EPC GaN switches with 1 MHz switching frequency in comparison to the estimated package dimension of a 1 kW GPU. Increasing the switching frequency of the IVR to the range of 10-100 MHz holds substantial potential for significantly minimizing its overall dimension. Considering the power delivery, the advanced packaging technologies enable higher interconnection density, wider bandwidth and lower loss and 3-D stacking is an enchanting solution. Multi-substrate glass interposer provides a solution for 3-D stacking of chips from different processes and technologies, as it incorporates flexible chip assemblies and thermal managements, and brings dense and low-loss vertical interconnects. In FIG. 17, the 3-D stack architecture for the 48/1 V, 1 kW, 4-phase, 8-module structure, employing two glass substrates and multiple ABF layers for interconnections is illustrated. In FIG. 17, modules are denoted as M1 to M8. In this design, high side switches (Q_{H1}-Q_{H4}) utilize a single EPC 2067 GaN switch, while low side switches (Q_{L}1-Q_{L}) employ two parallel switches. Series capacitors are integrated at the bottom of the lower glass substrate, and GaN chiplets are flip chipped beneath the capacitors using ABF layers. This configuration allows for the incorporation of a heat spreader or heat sink to mitigate GaN thermal issues. Within the second glass substrate, inductors and output capacitors are embedded. Considering the required inductance for the proposed converter, the MPC core (HBS1) in stands out as a favorable choice as a package inductor for the 3D stacked architecture, particularly at frequencies ranging from 1-10 MHz, given its saturation current exceeding 5 A. The size of the entire package is estimated, considering using an array of inductors with MPC magnetic cores. For the 4-phase, 8-module architecture, implementing at least 12 inductors is necessary and can be achieved through 4 arrays and 3 stacked layers. 3-dimensional view, top, front, and back cross-sections are illustrated, respectively, in FIG. 17. By extrapolating from the package dimensions and power specifications of the Ponte Vecchio GPU in FIG. 13A, we determined an estimated size for a 1 kW processor. Subsequently, a comparison was drawn between the estimated dimensions of the processor and those of the proposed 1 kW, 48/1V IVR located at the center of the processor, as depicted in FIG. 18.

As can be appreciated from the above, we introduced a novel 3-D stacked power delivery architecture designed for a 1 kW Processor. The core of our IVR incorporates an efficient multi-phase series capacitor (SC) buck converter, strategically eliminating switching losses at the CCM/DCM boundary. This innovative approach effectively addresses frequency limitations associated with 48-12/1 V IVRs, overcoming issues related to switching losses and limited turn-on time of power switches. Our analysis, encompassing configurations of 2-64 interleaved modules with 4-16 phases, indicates that a 4-phase architecture can achieve a maximum frequency of 25 MHz for 48/1 V conversion and 100 MHz for 12/1 V conversion. Incorporating the MPC core (HBS1) introduced in for embedded inductors in the 48/1 V architecture necessitates 12 parallel inductors, with values of 183 nH and 36.7 nH for 1 MHz and 5 MHz switching frequencies, respectively. The maximum dimensions of this inductor network, in 4 lateral and 3 stacked layers, would be 2.5 cm×10 cm×1.5 cm, reducible with higher frequencies and lower inductance values. The estimated dimensions for the 48/1 V, 1 kW package, with a 1 MHz, 4-phase, 8-module setup, are approximately 40 cm (length), 25 cm (width), without considering GaN gate drivers. This includes 96 EPC2067 GaN switches, 32 package inductors (each housing 12 embedded inductors), and 24 embedded series capacitors. The proposed 3-D stacked architecture with two glass substrates provides a 2.5 cm×10 cm space for high-voltage series capacitors within the lower glass substrate, presenting a promising area for future research. The use of flip chip GaN switches beneath the first substrate contributes to a low-profile architecture with minimal package thickness.

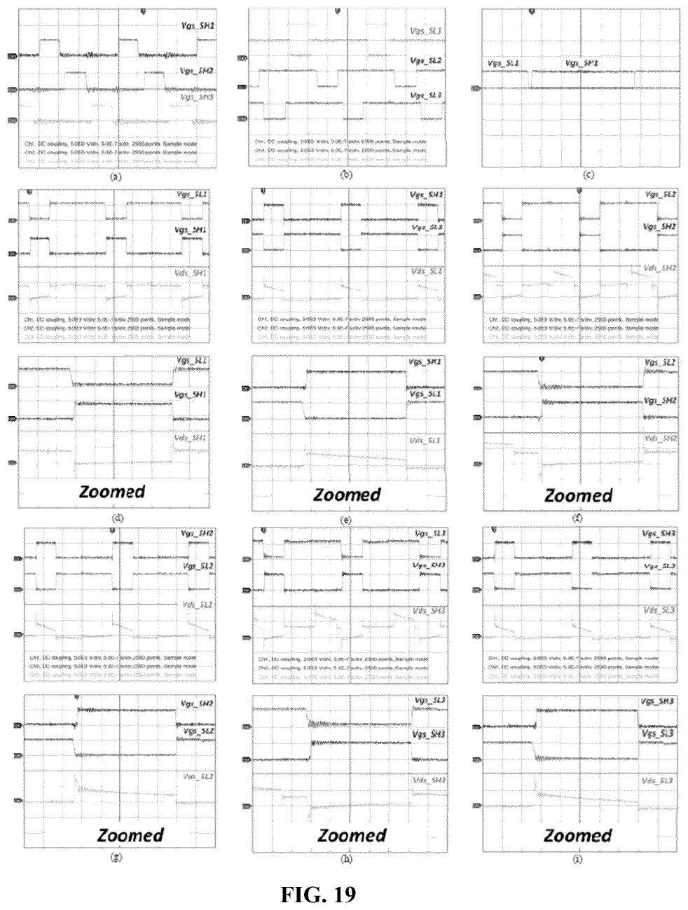

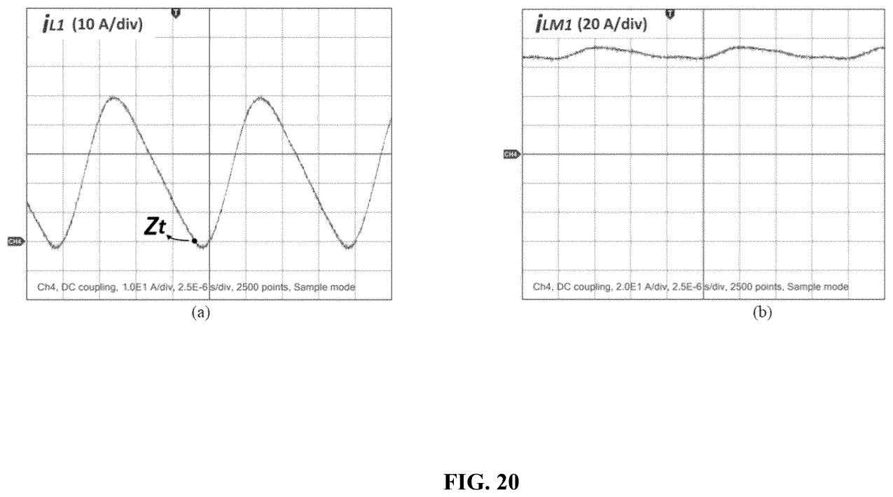

FIG. 19 (panels (a), (b), (c), (d), (e), (f), (g), (h), and (i)) show experimental waveforms for a module at a 0.5 MHz switching frequency with an output power of 67 W (P_{Total}: 200 W): (a) Gate-Source voltage of the high-side switches. b) Gate-Source voltage of low-side switches c) Gate-Source voltage of Phase-1 showing the required delay between switching events. ZVS soft switching operation for all switches with zoomed figures: d) S_{H1} e) S_{L1} f) S_{H2} g) S_{L2} h) S_{H3} i) S_{L3}. The switches' waveforms shown in FIG. 19 validate the theoretical analysis of the converter. FIG. 20 (panel (a)) shows the current waveform for one of the inductors and the summed inductor currents of the phases in the module, representing the output current of the module in FIG. 20 (panel (b). As can be appreciated, FIG. 20 shows (a) inductor current (i_{L1}) (b) output current of a module, i_{M1}. The current waveforms are captured at 100 kHz switching frequency instead of the nominal 500 kHz switching frequency due to the frequency limitations of the current probe.

### REFERENCES

The references listed below are incorporated herein by reference in their entireties.
Intel®, “Why Data Center GPUs Are Essential to Innovation”, https://www.intel.com/content/www/us/en/products/docs/discrete-gpus/data-center-gpu/what-is-data-center-gpu.html.
US Department of Energy, “Data Centers and Servers”, https://www.energy.gov/eere/buildings/data-centers-and-serversG.
K. Radhakrishnan, M. Swarninathan and B. K. Bhattacharyya, “Power Delivery for High-Performance Microprocessors—Challenges, Solutions, and Future Trends,” in IEEE Transactions on Components, Packaging and Manufacturing Technology, vol. 11, no. 4, pp. 655-671, A pril 2021, doi: 10,1109/TCPM.I′2021.3065690.
Y. Chen, K. Shi, M. Chen and D. Xu, “Data Center Power Supply Systems: From Grid Edge to Point-of-Load,” in IEEE Journal of Emerging and Selected Topics in Power Electronics, vol. 11. no. 3, pp. 2441-2456, June 2023, doi: 10.1109/JESTPE.2022.3229063.
M. Gong, X. Zhang and A. Raychowdhury, “Non-isolated 48V-to −1V Heterogeneous Integrated Voltage Converters for High Performance Computing in Data Centers,” 2020 IEEE 63rd International Midwest Symposium on Circuits and Systems (MWSCAS), Springfield, MA, USA, 2020, pp. 411-414, doi: 10.1109/MWSCAS48704.2020,9184442.
S. K. Moore, “Behind Intel's HPC Chip that Will Pierce the Exascale Barrier”, https://spectrum.ieee.org/intel-s-exascale-supercomputer-chip-is-a-master-class-in-3d-integration, Feb., 2022.
W. Gomes et at., “Ponte Vecchio: A Multi-Tile 3D Stacked Processor for Exascale Computing,” 2022 IEE EInternational Solid-State Circuits Conference (ISSCC), San Francisco, CA, USA, 2022, pp. 42-44, doi: 10.1109/ISSCC42614.2022.9731673.
Krishna Bharath et aL, “Integrated Voltage Regulator Efficiency Improvement using Coaxial Magnetic Composite Core Inductors,” IEEE Elec. Components and Tech. Conf., pp. 1286-1292, 2021
C. A. Barros et al., “Proposed Inductor Power Loss Metric and Novel Embedded Toroidal Inductor for Integrated Voltage Regulators,” in IEEE Transactions on Components, Packaging and MFlanufacturing Technology, vol. 11, no. 11, pp. 1935-1947, Nov. 2021, doi: 10.1109/TCPMT.2021.3116942.
C. Alvarez Barros et al., “Embedded Inductors Using Composite Magnetic Materials for 12-1-V Integrated Voltage Regulators,” in IEEE Transactions on Components, Packaging and Manufacturing Technology, vol. 11, no. 12, pp. 2183-2192, Dec. 2021, doi: 10.1109/TCPMT.2021.3116946
W. J. Lambert, M. J. Hill, K. Radhakrishnan, L. Wojewoda and A. E. Augustine, “Package Inductors for Intel Fully Integrated Voltage Regulators,” in IEEE Transactions on Components, Packaging and manufacturing Technology, vol. 6, no. 1, pp. 3-11, Jam 2016, doi: 10.1 109/TCPMT.2015.2505665.
Schaef et al., “Fully Integrated Voltage Regulator in 14 nm CMOS with Package-Embedded Air-Core Inductor Featuring Self-Trimmed, Digitally Controlled Variable On-Time Discontinuous Conduction Mode Operation,” 2019 IEEE International Solid-State Circuits Conference-(ISSCC), San Francisco, CA, USA, 2019, pp. 154-156, doi: 10.1109/ISSCC.2019.8662294.
Y. Dou, Z. Ouyang, P. Thummala and M. A. E. Andersen, “PCB embedded inductor for high-frequency ZVS SEPIC converter,” 2018 IEEE Applied Power Electronics Conference and Exposition (APEC), San Antonio, TX, USA, 2018, pp. 98-104, doi: 10.1109/APEC.2018.8340994.
N. Sturcken, R. Davies, C. Cheng, W. E. Bailey and K. L Shepard, “Design of coupled power inductors with crossed anisotropy magnetic core for integrated power conversion,” 2012 Tweny-Seventh Annual I EEE Applied Power Electronics Conference and Exposition (APEC), Orlando, FL, USA, 2012, pp. 417-423, doi: 10,1109/APEC.2012.6165853,
C..-L. Chen et al., “Ultra-low-resistance 3D InFO inductors for integrated voltage regulator applications,” 2016 IEEE International Election Devices leeting (IEDM), San Francisco, CA, USA, 2016, pp. 35.2.1-35.2.4, doi: 10.1109/IED1v1M.2016.7838546. D. Yu, “A new integration technology platform: Integrated fan-out wafer-level-packaging for mobile applications,” 2015 Symposium on VLSI Technology (VLSI Technology), Kyoto, Japan, 2015, pp. T46-T47, doi: 10.1109/VLSIT.2015.7223697. E, A. Burton et aL., “FIVR-Fully integrated voltage regulators on 4th generation Intel@Core™ SoCs,” 2014 IEEE Applied Power Electronics Conference and Exposition-APEC 2014, Fort Worth, TX, USA, 2014, pp. 432-439, doi: 10.1109/APEC.2014.6803344.
M. Sankarasubramanian et al., “Magnetic Inductor Arrays for Intel® Fully Integrated Voltage Regulator (FIVR) on 10th generation Intel@Core^{T}SoCs,” 2020 IEEE 70th Electronic Cornponents and Technology Conference (ECTC), Orlando, FL, USA, 2020, pp. 399-404, doi: 10.1109/ECTC32862.2020.00071,
P. Murali et al., “Fabrication and characterization of package embedded inductors for integrated voltage regulators,” in 2022 IEEE 72nd Electronic Components and Technology Conference (ECTC), 2022, pp. 301-305.
T. Fukuoka et al., “An 86% efficiency., 20 MHI-z, 3D-integrated buck converter with magnetic core inductor embedded in interposer fabricated by epoxy/magnetic-filler composite build-up sheet,” in Proc. IEEE Appl. Power Electron. Conf. Expo. (APEC), Mar. 2019, pp. 1561-1566.
H. T. Le et al., “High-Q three-dimensional microfabricated magnetic core toroidal inductors for power supplies in package,” IEEE Trans. Power Electron., vol. 34, no. I, pp. 74-85, Jan. 2019.
S. L, Selvaraj et al., “On-chip thin film inductor for high frequency DC-DC power conversion applications,” in Proc. IEEE Appl. Power Electron. Conf. Expo. (APEC), Mar. 2020, pp. 176-180.
R. Murphy, Z. Pavlovic, P. McCloskey, C. O Mathuna, S. O'Driscoll, and G. Weidinger, “PCB embedded toroidal inductor for 2 MHz pointof-load converter,” in Proc. I Ith Int. Conf. Integr. Power Electron. Syst. Mar. 2020, pp. 1-5.
C. Alvarez et al., “Demonstration of a High-Inductance, High-Density, and Low DC Resistance Compact Embedded Toroidal Inductor for IVR,” 2021 IEEE 71st Electronic Components and Technology Conference (ECTC), San Diego, CA, USA, 2021, pp. 1293-1299, doi: 10.1109/ECTC32696.2021.00209.
Techpowerup, “Gigabyte GeForce GTX 1650 Super WindForce OC Review”, https://www.techpowemp.com/review/gigabyte-geforce-gtx-1650-super-windforce-oc/3.html.

It should be understood that the disclosure of a range of values is a disclosure of every numerical value within that range, including the end points. It should also be appreciated that some components, features, and/or configurations may be described in connection with only one particular embodiment, but these same components, features, and/or configurations can be applied or used with many other embodiments and should be considered applicable to the other embodiments, unless stated otherwise or unless such a component, feature, and/or configuration is technically impossible to use with the other embodiment. Thus, the components, features, and/or configurations of the various embodiments can be combined together in any manner and such combinations are expressly contemplated and disclosed by this statement.

It will be apparent to those skilled in the art that numerous modifications and variations of the described examples and embodiments are possible considering the above teachings of the disclosure. The disclosed examples and embodiments are presented for purposes of illustration only. Other alternate embodiments may include some or all of the features disclosed herein. Therefore, it is the intent to cover all such modifications and alternate embodiments as may come within the true scope of this invention, which is to be given the full breadth thereof.

It should be understood that modifications to the embodiments disclosed herein can be made to meet a particular set of design criteria. Therefore, while certain exemplary embodiments of the systems, compositions, materials, apparatuses, and methods of using and making the same disclosed herein have been discussed and illustrated, it is to be distinctly understood that the invention is not limited thereto but may be otherwise variously embodied and practiced within the scope of the following claims.

What is claimed is:

1. A voltage regulator, comprising:
plural phase blocks, the plural phase blocks including a single-stage multi-phase series capacitor buck converter that operates at a boundary between continuous conduction mode and discontinuous conduction mode.

2. The voltage regulator of claim 1, comprising:
plural processing modules, each processing module including one or more phase blocks.

3. The voltage regulator of claim 1, wherein:
at least two phase blocks are connected in parallel.

4. The voltage regulator of claim 1, wherein:
each phase block is connected in parallel with each other phase block.

5. The voltage regulator of claim 1, wherein the plural phase blocks includes:
an input phase block, comprising:
a first diode switch, a second diode switch, a capacitor, and an inductor;
an output phase block, comprising:
a first diode switch, a second diode switch, and an inductor.

6. The voltage regulator of claim 5, further comprising:
an output capacitor.

7. The voltage regulator of claim 4, wherein:
the input phase block includes plural phase blocks.

8. The voltage regulator of claim 1, wherein the plural phase blocks includes:
an input phase block, comprising:
a first diode switch connected to node 1 and connected to node 2;
a capacitor connected to node 2 and connected to node 3;
a second diode switch connected to node 3; and
an inductor connected to node 3 and node 4;
an output phase block, comprising:
a first diode switch connected to node 2 and node 5;
a capacitor connected to node 5 and node 6;
a second diode switch connected to node 6; and
an inductor connected to node 6 and node 7; and
an output capacitor connected to node 4, node 7, and node 8.

9. The voltage regulator of claim 8, wherein:
the second diode switch connected to node 3 includes an amplifier;
the second diode switch connected to node 6 includes an amplifier; and/or
the output capacitor includes an amplifier.

10. The voltage regulator of claim 7, further comprising:
a voltage source configured to generate a Vᵢₙ at node 1;
wherein the voltage regulator is configured to generate a Vout at node 8.

11. The voltage regulator of claim 1, wherein the plural phase blocks includes:
a first processing module, comprising:
an input phase block, comprising:
a first diode switch connected to node 1 and connected to node 2;
a capacitor connected to node 2 and connected to node 3;
a second diode switch connected to node 3; and
an inductor connected to node 3 and node 4;
an output phase block, comprising:
a first diode switch connected to node 2 and node 5;
a capacitor connected to node 5 and node 6;
a second diode switch connected to node 6; and
an inductor connected to node 6 and node 7; and
a second processing module, comprising:
an input phase block, comprising:
a first diode switch connected to node 1 and connected to node 2;
a capacitor connected to node 2 and connected to node 3;
a second diode switch connected to node 3; and
an inductor connected to node 3 and node 4;
an output phase block, comprising:
a first diode switch connected to node 2 and node 5;
a capacitor connected to node 5 and node 6;
a second diode switch connected to node 6; and
an inductor connected to node 6 and node 7; and
an output capacitor connected to node 4, node 7, and node 8 of the first processing module and connected to node 4, node 7, and node 8 of the second processing module.

12. The voltage regulator of claim 10, further comprising:
a voltage source configured to generate a Vᵢₙ at node 1 of the first processing module and node 1 of the second processing module; and
wherein the voltage regulator is configured to generate a Vout at node 8 of the first processing module and node 8 of the second processing module.

13. The voltage regulator of claim 11, further comprising:
a load connected to node 8 of the first processing module and connected to node 8 of the second processing module.

14. A method for regulating voltage, the method comprising:
applying a voltage to a voltage regulator, the voltage regulator comprising plural phase blocks including a single-stage multi-phase series capacitor buck converter;
causing or allowing the single-stage multi-phase series capacitor buck converter to operate at a boundary between continuous conduction mode and discontinuous conduction mode.
